(19) United States
(12) Patent Application Publication
(10) Pub. No.: US 2024/0174464 A1
(43) Pub. Date: May 30, 2024

(54) Robot Logistics System

(71) Applicants: George G. Moser, Santa Clara, CA (US); Carol M. Moser, Santa Clara, CA (US)

(72) Inventors: George G. Moser, Santa Clara, CA (US); Carol M. Moser, Santa Clara, CA (US)

(21) Appl. No.: 18/161,050

(22) Filed: Jan. 28, 2023

Related U.S. Application Data
(60) Provisional application No. 63/398,170, filed on Aug. 15, 2022.

(51) Int. Cl. B65G 67/24; B25J 15/06; B65G 1/137; B65G 61/00; G05D 1/667; G05D 109/12; G06Q 10/083

(52) U.S. Cl. CPC B65G 67/24; B65G 1/137; B65G 61/00; G05D 1/667; B25J 15/0616; G05D 2109/12; G06Q 10/083

(57) ABSTRACT

An automated delivery system includes an electric vehicle equipped with an overhead Cartesian Robot in the cargo area, enabling it to extract packages from the cargo area while the vehicle is traveling to its next destination, and deposit them in a staging area in the cabin, so that the driver and/or the optional robotic assistants can drop them off immediately upon arrival. Drivers need not be involved in loading the vehicles, which can be done automatically at a warehouse Load Cell, which may be available continuously, so the vehicle will not be delayed waiting for packages to be loaded into it. Packages may be loaded by the Load Cell before the drivers arrive at the vehicle, so vehicles are ready to go.

### 1. FIELD OF THE INVENTION

The present invention relates to the fields of Robotics and Artificial Intelligence.

### 2. BACKGROUND

Today, the number of consumers purchasing goods online has put tremendous pressure on the shipping operations of e-commerce retailers and shipping carriers. Ecommerce retailers (e.g., Amazon, Walmart, Target) and the shipping carriers that they employ in addition to their own delivery operations (UPS, FedEx and others) must manage the shipping of a growing number of deliveries worldwide, with growing consumer expectations in terms of speed. Second Day, Next Day and even Same Day are becoming the new expectation and the new norm in ecommerce.

To cope with these demands, ecommerce retailers and shipping carriers have begun to automate portions of their order fulfillment and distribution processes, with a focus on warehouse operations. In addition, e-retailers have started exploring package delivery by drone, biped robots, quadruped robots and autonomous driving vehicles. However, to date the level of automation in delivery operations is still minimal, due to remaining technical and implementation challenges, which the present invention addresses.

In particular, the “last mile” of the delivery process is currently carried out manually by human workers. The term “last mile” refers to the last stage in the package delivery process, from the local distribution center to the addresses of customers, which is done by human drivers performing the following functions:
manually loading bags containing the packages to be delivered into delivery vehicles;
driving the vehicle to the customer destination;
parking the vehicle at the customer destination;
searching the cargo area for the right package for that destination;
scanning the correct package (s) for that destination and carrying them to the customer door.

FIG. 1 describes the state of the art in the “last mile” package delivery to customers. In Step 1, warehouse workers manually sort the packages by delivery route. To do this the warehouse worker needs to quickly identify which packages on the warehouse conveyor belt belong in which delivery route by reading a code printed on a small label on each package. Workers pick up and collect packages from the belt per delivery route according to that code.

In Step 2 warehouse workers fill the Delivery Bags with packages. Each bag typically holds packages to be delivered to addresses close to one another on the same delivery route. For example, if a delivery vehicle holds 20 Delivery Bags, the first bag may hold packages for stops 1 through 15, the second bag may hold packages for stops 16-25, and so on. The total number of packages per vehicle is typically in the range from 200-300 packages per day.

In Step 3, when the Delivery Bags have been filled, the driver manually loads the Delivery Bags (and any oversized packages that do not fit into the Bags) into the delivery vehicle. This is a completely manual process. To load a vehicle, the driver has to pick up each one of the 20-30. Delivery Bags full of packages, carry it into the cargo area, lift it to place on a shelf in the vehicle's cargo area and deposit it on the shelf. Each Bag weighs up to 50 pounds, so this is a heavy physical activity suitable only for strong individuals.

While loading the Delivery Bags into the vehicle, the driver has to manually sort and arrange the delivery bags into route order, with the packages to be delivered first placed at the front of the cargo area and packages to be delivered later in the route placed at the back of the cargo area. Drivers often handwrite reminders or codes directly onto packages to help them organize and locate packages. Quite often, drivers cannot place oversized and oddly shaped packages into route order and must simply place them wherever they might fit in the cargo area. Delivery bags on the shelves and packages inside the Delivery Bags can move and shift, and sometimes fall while the vehicle is driving, leading potentially to a chaotic situation that can be time-consuming to sort out upon arrival at each destination.

In Step 4 the Driver drives the vehicle to the delivery destination.

In Step 5 the driver must walk into the cargo area of the vehicle, search and locate the package (s) for that stop.

In Step 6, the driver then carries the package (s) to the customer's front door and drops them off there.

In Step 7, the driver scans the package to validate the delivery and photographs the packages sitting in their drop-off location. The driver walks back to the vehicle.

This process is repeated for every route stop. While driving the route, packages in the vehicle's cargo area often move out of order. When this happens, the driver must reorganize packages into route order. Once all delivery stops have been made, the driver returns the vehicle to the distribution facility along with any undeliverable packages.

In summary, package delivery is currently a manual system with some routing software assistance and package labeling to help workers manually sort the packages to fit into a reasonable driving sequence. The system works, but it is very labor intensive and therefore extremely costly.

The prior art also includes some attempts to automate the delivery process.

U.S. Pat. No. 11,442,419 B2 (Heinla et all) discloses a small wheeled mobile robot configured for vending consumable items, covered with a lid. This robot cannot open doors, which limits its practicality. A customer places an order, pays with a credit card and the robot goes to meet the customer at an agreed meeting point. The customer has to open and close the lid, and retrieve the food and/or drinks from the inside of the robot. That doesn't constitute true delivery, because the robot cannot deliver, a person is needed for that. Consumer feedback for this type of robot has generally not been good. Similar products have been pilot-tested extensively, generating negative customer feedback. One of the major shortcomings is the inconvenience of having to wait for the robot to arrive, since the robot is not able to deliver by itself. The customer is stuck waiting, not ideal. They are also not scalable because of the very small size of the compartment for the items being delivered.

U.S. Pat. No. 11,507,100 B2 (Sibley) discloses a robot delivery system to deliver an article from a first location to a second location, which includes a transport mechanism for presenting the article to be dispensed to a recipient. The availability of a dispensing mechanism is to some extent an improvement compared to the previous patent. However, the high complexity of that dispensing mechanism put the practicality in doubt. The system is small and not scalable because of size, small capacity and excessive complexity, so it doesn't really address the needs of the ecommerce industry.

U.S. Pat. No. 11,518,291 B2 (Buttolo) discloses a self-driving autonomous delivery vehicle that relies on the recipient of the delivery to pick it up, but to prevent that the wrong package is picked up, the vehicle selectively unlocks the correct compartment and keeps all other compartments locked. It's an interesting, possibly workable mechanism, but it is not for use at scale, only for small shipments. At scale there is no need nor time to lock and unlock compartments and the packages must be delivered, not just presented to the customer, who is expected to retrieve them from the vehicle.

Pub. US 2022/0396192 A1 (Paul et all) discloses a complete Automated Storage and Retrieval System (such as those used in warehouses) built into the cargo area of a delivery truck. The cargo area ends up completely full of drawers containing the packages. The packages must be loaded into the truck through a receiving station in the rear of the truck one by one, and a robot and/or conveyor system takes them to another location in the vehicle, where a second robot picks them up and stores it into a lockable drawer. At retrieval time, a third robot (or the same second robot) searches for the package to be retrieved and puts it on a conveyor belt, which sends it to the driver in the front of the vehicle. There are several issues: the time needed to load the packages into the vehicle will keep the vehicle grounded for a long time, hurting efficiency, one of the biggest known deficiencies of the current delivery systems in ecommerce. The cargo area full of drawers is not accessible for repairs or malfunction resolution when the drawers get stuck, which will happen inevitably. The number of robots and conveyor belts operating inside the vehicle is also unrealistic, because the vehicle is full of drawers, and there is no space available for robots or conveyors to operate, considering that to function they must rotate, move and extend, with a large working envelope. Also, such a structure would be very expensive, unreliable and impractical due to excessive complexity. This is a completely different structure from the RDV of the present invention and it doesn't meet basic requirements of the ecommerce industry.

Pub. US 2022/0281371 A1 (Meador) discloses an autonomous delivery vehicle with an internal conveyor that selectively presents the package to be delivered to a recipient, who retrieves it from the vehicle. It is suitable for a small number of packages (approximately 10 packages per vehicle) and the conveyor system could work in some niche applications, but this solution falls short of the needs for ecommerce package delivery at scale (at least 300 packages per vehicle).

### SUMMARY

The Automated Logistics System (ALS) is a novel, automated system for sorting, loading, and delivering packages. The system typically includes the following components:

4.1 RDV (Robotic Delivery Vehicle) is a delivery vehicle that can be electric, hybrid or internal combustion powered, with a strong preference for electric vehicles in order to avoid pollution. The RDV is equipped with a Package Handling Robot which performs all cargo operations in the vehicle. In the preferred embodiment of the invention, a Cartesian Robot is used, typically located near the roof of the cargo area. The Cartesian Robot provides higher accuracy, robustness and speed. The Cartesian robot is managed by a Computer Control System in the RDV, and under its management it performs all cargo operations in the RDV, including but not limited to locating packages for next drop-off, picking up, carrying and transferring packages to the cabin and depositing them in the staging bins to be ready for immediate drop-off upon arrival at the next destination.

The Cartesian Robot picks up the packages for the next delivery out of the cargo area while the vehicle is driving and moves them to the cabin into a box called the Staging Bin next to the driver, so that when the vehicle arrives to its destination, the packages will be ready for the driver to quickly grab them on his way out of the truck and drop them off. Alternatively, the Cartesian Robot can deposit the packages into the carrying bin of a delivery robot who is waiting by the driver, ready to exit the vehicle upon arrival and drop off the packages at the customer door (we call this delivery robot the last yard robot).

The Cartesian Robot needs a very long telescopic pickup actuator to be able to reach packages from the floor level to near the roof of the vehicle, without the retraction of the actuator interfering with the roof of the vehicle. That task can be accomplished in this invention with hydraulic, pneumatic, mechanical or other mechanisms. The preferred embodiment of the invention uses an innovative custom telescopic actuator that is part of this invention and that provides superior reliability, speed and accuracy.

The RDV does not have shelves or other structures in the cargo area to hold the packages in place while driving. All those structures are not part of the RDV, because they would make the loading of packages into the RDV slow and difficult. Instead, the packages are loaded separately into Cribs at the warehouse (see 4.2 Cribs). The Cribs are not part of the RDV, which has an almost completely empty cargo area.

The uncluttered, open, and available cargo area has major advantages:
Flexibility: the same RDV can be used, without redesigning the vehicle, for different types and sizes of Cribs (large/small packages, heavy/light packages, sturdy/delicate packages, etc.).
Standardization: the same RDV can be used across many different industries just by modifying the Cribs, without redesigning the RDV (food delivery, construction materials, medications, etc.).
Customization: the RDV can be easily customized for certain shipments or businesses, by adding refrigeration (for perishable items, such as some foods and some medications), heating (such as pizza, restaurant food, fast food, etc.) and other special needs that will arise as ecommerce grows and gets into new areas.

4.2 CRIBS are big plastic or metal boxes with internal partitions (typically 2 Cribs per vehicle), that securely hold packages in a predetermined delivery order inside the vehicle in a way that the packages cannot be accidentally shifted, shuffled, mingled, mixed, disturbed or altered in their sequence due to the vehicle movement, thereby always preserving the correct routing sequence.

The Cribs are filled with packages at the warehouse (not at the vehicle) and then the full Cribs are moved to the RDV and quickly inserted into the back of the vehicle in a very quick operation (measured in seconds). Therefore, the vehicle is never immobilized for a long time while being loaded. Cribs can be loaded 24/7 at the warehouse, so that full Cribs can always be ready to be inserted into the vehicle when needed. Furthermore, the driver does not have to load the vehicle anymore, unlike current practice, so the driver doesn't need to be a strong individual. This will reduce work injuries from loading and it will expand the hiring pool of drivers (no heavy lifting requirements anymore).

4.3 LOAD CELL is an automated Crib loading system located at the distribution center or warehouse, which loads the packages into the Cribs in the correct routing sequence for optimized driving. The Load Cell can be standalone, as shown in see FIG. 31, or integrated into the warehouse or distribution center

4.4 LAST YARD DELIVERY ROBOTS are typically in the cabin next to the driver (alternatively they could also be in the cargo area in some embodiments). We call them Last Yard Robots, because they focus specifically on the short distance between delivery vehicle and drop-off point, which is typically just yards away, and they are optimized for that function. They spring into action as soon as the vehicle arrives at its destination, exiting the vehicle with the packages handed over to them by the Cartesian Robot. They drop them off at the customer's door and rush back to the vehicle.

The Quadruped Carrier (QC) is one of these delivery robots. It is an innovative wheeled robot that is able to roll on its wheels on smooth terrain, or switch to a walking gait on the fly in the presence of obstacles, rough terrain or stairs. The QC can carry packages in a top-loading bin on its back and has innovative features that allow it to safely and gently deposit the packages at the customer's door, without requiring the presence of the customer or any assistance whatsoever.

The Biped Carrier (BC) is the second delivery robot. It is a new innovative robot with special features on its feet that enable it to swiftly roll on smooth terrain or switch to a walking gait on the fly to overcome obstacles or climb stairs. The biped robot is equipped with a chest pack that enables it to carry packages while keepings its hands free, and safely and gently deposit the packages at the customer's door, without requiring the presence of the customer or any assistance whatsoever. The biped robot can carry packages in his chest pack, in his arms, in his grippers, in a delivery bag, in a dolly or in a cart.

4.5 DELIVERY SOFTWARE SYSTEM, a set of computer programs distributed across the Robotic Delivery Vehicle, the Last Yard Delivery Robots and the Load Cell, which performs the following tasks:
assigns packages a position in the Crib based on route order and package size;
runs a program for finding packages and extracting them from the Cribs for the next route stop, which is done during drive time;
determines the best staging location for each package in the vehicle (i.e., the vehicle's Staging Area next to the driver, or the QC bin, or the biped's Actuators, chest bag or shoulder bag);
reorganizes packages in the Cribs when the delivery route must change due to traffic, weather conditions or other reasons;
loads and records any undeliverable packages, and more.

4.6 The TRACTIVE ROBOTS are optional small transportation robots with very low profile that can go under the Cribs and attach to them to move them to a desired location, such as loading it into the RDV or returning it into the warehouse when empty. The Tractive robots can move Cribs wherever needed including in and out of the delivery vehicle. The Tractive robots do not lift the whole Crib, they just attach to it through a system of pins and use their traction electric motors to move the Cribs to any desired location. In addition to Tractive Robots, the Cribs can also be loaded into the vehicle with a forklift, especially if non-wheeled Cribs are used.

### BRIEF DESCRIPTION OF THE DRAWINGS

FIG. 1 is a flowchart of a prior art process for package delivery in the e-commerce industry.

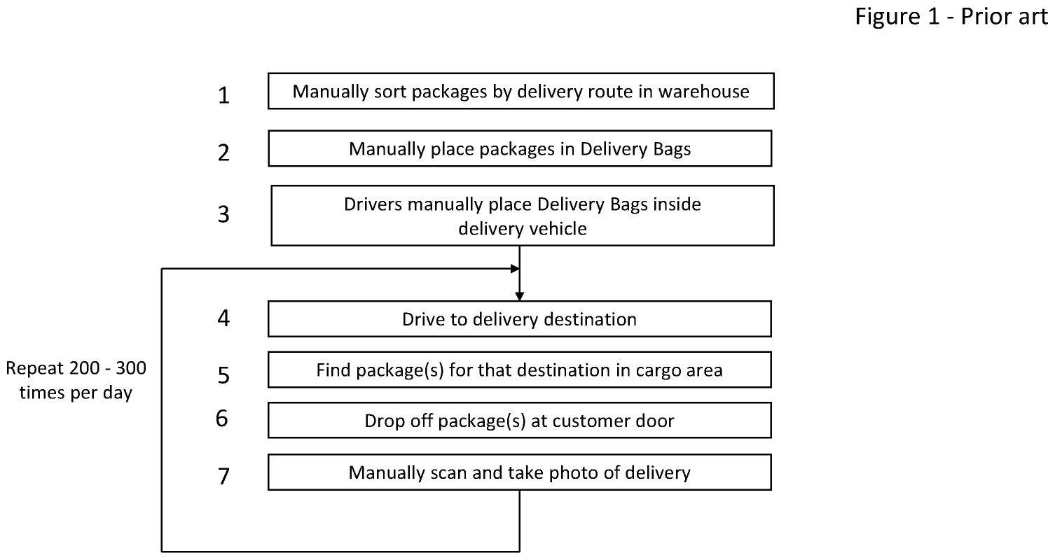

FIG. 2 is a perspective view of a Robotic Delivery Vehicle (RDV).

FIG. 3 shows a Delivery Crib with a front door for oversized packages.

FIG. 4 is a perspective vehicle view illustrating Front and Rear Delivery Cribs.

FIG. 5 is a perspective view of a forklift inserting a Crib into the delivery vehicle.

FIG. 6 is an upper perspective view of the RDV and the Cribs.

FIG. 7 shows a side view of a Biped Delivery Robot carrying a package.

FIG. 8 is a perspective view of the special foot of a Biped Robot in retracted position.

FIG. 9 illustrates the special foot of a Biped Robot in deployed position.

FIG. 10 is a perspective view of a biped Last Yard Delivery Robot with a drop-off bag.

FIG. 11 is a side view of the biped Last Yard Delivery Robot with a drop-off bag.

FIG. 12 is a perspective view of the Robotic Delivery Vehicle (RDV), Cribs and staging areas.

FIG. 13 is a perspective view of the RDV, Cribs and Quadruped Last Yard Delivery robot.

FIG. 14 is a perspective view of the RDV with a human driver plus biped robot assistant.

FIG. 15 is a perspective view of the RDV with a human driver plus two robot delivery assistants.

FIG. 16 is a perspective view of the RDV in self-driving mode with one delivery robot inside.

FIG. 17 is a perspective view of the RDV in self-driving mode plus 2 delivery robots.

FIG. 18 is a perspective view of the innovative Quadruped Carrier (QC) of this invention.

FIG. 19 shows the Quadruped Carrier rolling to make a delivery.

FIG. 20 shows the Quadruped Carrier in package drop-off mode.

FIG. 21 shows the Quadruped starting to open its front lid to deliver.

FIG. 22 shows the Quadruped performing a package drop-off.

FIG. 23 is a perspective view of a Quadruped with a multi-compartment top bin.

FIG. 24 shows a Quadruped delivering the contents of its front compartment.

FIG. 25 shows a Quadruped delivering the contents of its middle compartment.

FIG. 26 shows a Quadruped delivering the contents of its rear compartment.

FIG. 27 (a) is a front perspective view of a Quadruped with a robotic arm for deliveries; FIG. 27 (b) is a rear perspective view of the Quadruped with a robotic arm for deliveries.

FIG. 28 is a front perspective view of the Quadruped Carrier with a friendly face and attitude.

FIG. 29 is a side perspective view of the Quadruped Carrier with a friendly face and attitude.

FIG. 30 is a schematic diagram showing the delivery system flow, in accordance with an embodiment.

FIG. 31 is a perspective view of the Load Cell where Cribs are loaded.

FIG. 32 is an upper perspective view of the Load Cell for Cribs.

FIG. 33 is a perspective view of the Tractive Robot with retracted pins.

FIG. 34 is a perspective view of the Tractive Robot with pins in deployed position.

FIG. 35 is a perspective view of a Tractive Robot getting underneath a Crib to move it.

FIG. 36 is a perspective view of a Tractive robot moving a Crib.

FIG. 37 is a rear perspective view of the Robotic Vehicle with ramp for automatic Crib loading.

FIG. 38 shows a cross-section of the custom Telescoping Actuator.

FIG. 39 shows cross-sectional views of the initial stages of Telescopic Actuator Deployment.

FIG. 40 shows cross-sectional views of the final stages of Telescopic Actuator Deployment.

FIG. 41 shows the Telescoping Actuator with motor, suction cup and sensor.

### DETAILED DESCRIPTION

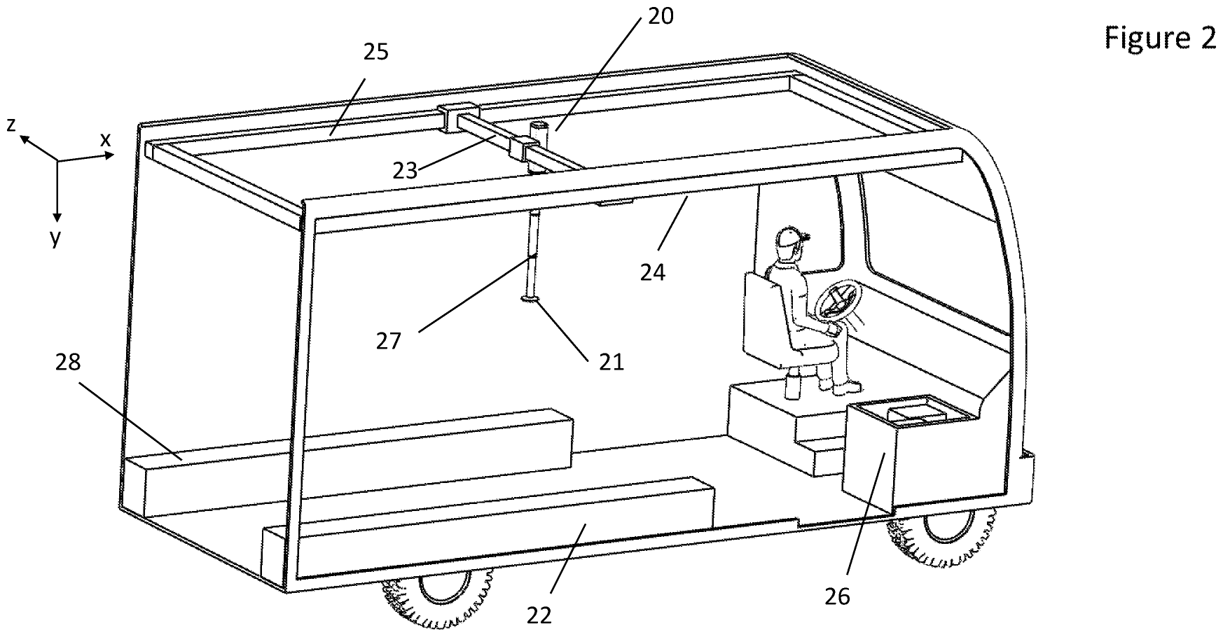

FIG. 2 shows a preferred embodiment of the ROBOTIC DELIVERY VEHICLE (RDV), the innovative delivery vehicle of this invention. It includes at least one Robot, in this embodiment a Cartesian Robot 20 in the cargo area of the vehicle, near the roof. The Cartesian Robot performs all cargo handling operations in the vehicle, such as scanning, identifying, searching, picking, lifting, carrying, reorganizing, moving, sorting, and transferring packages inside the vehicle from any point A to any point B. It is able to perform multiple functions with packages such as scanning, identifying, picking, lifting, carrying, transferring to other areas of the vehicle, and depositing them in the desired location (s).

Other types of robots could also perform these operations, such as: Articulated Arm Robots with 4, 5, or more 6 axis, Swiveling SCARA robots, rotating Cylindrical Robot, combinations of different types of robots, or robots equipped with additional components such as carriages, rotating bases or other features which help them achieve the desired functions, and other robots.

The Cartesian Robot 20 basically consists of two supporting rails 24 and 25 fixedly attached to the vehicle near the roof, and a bridge 23, which is slidably attached to the rails and therefore can move along the rails in X direction. A telescopic actuator 27 is slidably attached to the bridge, hence it can move back and forth along the bridge in Z direction. The telescopic actuator can also extend or retract to move its gripper or suction cup 21 up or down (Y direction). Therefore, the Cartesian Robot can reach any point with any coordinates (X, Y, Z), within the cargo area and most of the cabin area.

The RDV further includes a staging bin 26, which is basically a box for holding the packages for the next stop in the route. The Cartesian robot fills this staging area with packages during drive time, so the packages are ready for immediate drop-off upon arrival.

FIG. 2 shows that the cargo area of the RDV is almost completely empty, with the exception of the cartesian robot near the roof, and the wheel wells 22 and 28, which may also contain batteries and electronic systems for the vehicle. There are no structures, fixtures or mechanisms in the cargo area to hold the packages and organize them. This is intentional. The packages are not loaded at the vehicle, but instead at the warehouse, into large boxes called Cribs, using an automated facility called a Load Cell, which is also an important part of this invention. Each Crib can hold hundreds of packages. In a preferred embodiment, each vehicle will typically hold 2 Cribs. The Cribs are loaded into the back of the vehicle by a forklift or by small tractive robots, in an operation that takes just seconds. With this approach, the vehicle is not grounded waiting for the completion of a time-wasting loading process at the vehicle. It also keeps the vehicle simple, clean, cost-effective, flexible, reliable, easy to maintain (not much can go wrong), low complexity and highly efficient.

Looking again at FIG. 2, the cartesian robot inside the vehicle performs all cargo handling in the vehicle. As the delivery vehicle is driving, the vehicle's Telescopic Actuator 27 is constantly locating, scanning, picking up and carrying packages to the vehicle's staging areas in the cabin to assemble the next batch of packages to be dropped-off at the next route stop.

The Telescopic Actuator 27 can be designed in many different ways to accomplish the functions needed for this invention. It can be configured in many ways:
as a hydraulic telescopic cylinder;
a telescoping air cylinder;
a flexible rack and pinion mechanism similar to a deployable antenna;
a multi-link robotic actuator;
an extendable and retractable scissor-mechanism;
a telescoping actuator based on cables or ropes; and
other approaches and configurations, all within the scope of this invention.

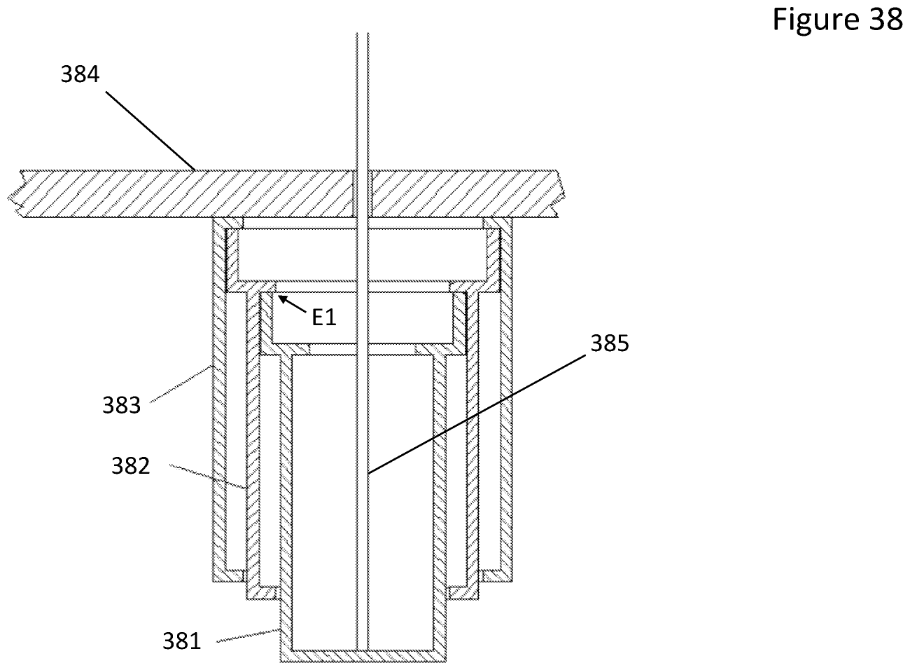

The preferred solution for the Telescoping Actuator in the preferred embodiment is a custom telescoping actuator designed specifically for this invention is disclosed below in this Specification and shown in FIGS. 38-41.

The basic required functionality of the telescoping actuator in this invention is the ability to reach from a high point close to roof down to a low point close to the floor of the vehicle, and extract and move packages to transfer them to either other compartments (to reorganize cargo when needed) or to the delivery staging area in the cabin of the vehicle. The actuator must have a very long stroke, so it can navigate over the Cribs in retracted position and also extend deep downward to retrieve a package near floor level, but without interfering with the roof when the actuator is retracted. That can be achieved with any of the above-mentioned methods (hydraulic, pneumatic, mechanical, etc.), or by the custom telescopic actuator designed specifically for this invention, which is disclosed in detail further below.

The Telescoping Actuator 27 can be fitted with a number of different picking tools including, for example, a suction cup 21 or a gripper or many others. It can also be equipped with a position sensor at the end to warn the system when it is approaching an object or a package, and slow down, stop or reverse. The sensor can be a sophisticated proximity sensor, or a simple reliable and cost-effective electric switch, that reports arrival to a desired position when the switch is opened or closed by its protruding probe. The Telescoping Actuator 27 can also retool itself with different suction cups, grippers, sensors or other tools as needed.

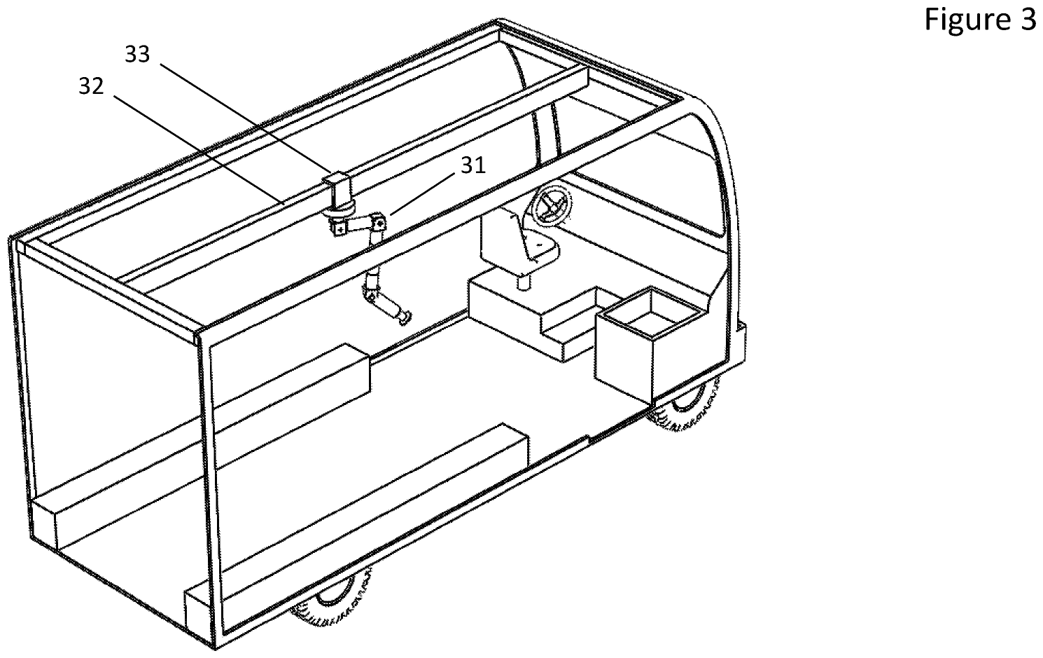

FIG. 3 shows as an example an additional embodiment of the invention. The Articulated Robot 31 can slide along a longitudinal rail 32 to position itself correctly with respect to the package to be picked up from the cargo area. Then it deploys its articulated arm to perform the pickup. The articulated robot arm in this example also has a slider 33 to slide along the longitudinal rail 32, and a rotating base attached to the bottom of the slider, to facilitate the rotation of the complete arm when needed. Optionally, it is also possible to mount a telescopic actuator at the end of the articulated arm (not shown in this Figure), to facilitate reaching down to low levels in the cargo area, such as near the floor.

The preferred embodiment of this invention uses a Cartesian Robot because of its robustness, high accuracy and simplicity, which provides high reliability, trouble-free operation, reasonable cost and longevity.

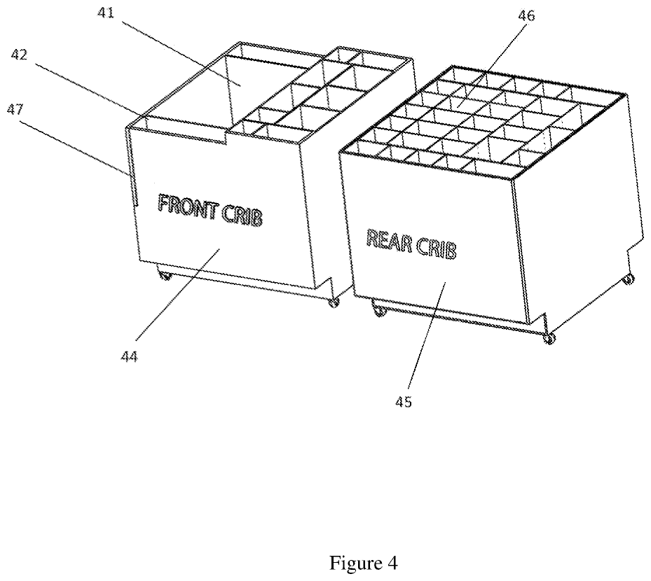

FIG. 4 shows two large Cribs 44 and 45 that will be filled with the packages to be delivered. The Cribs are intentionally NOT part of the vehicle. The loading of packages is performed at a different location (at the warehouse or distribution facility), in order not to immobilize the vehicle while loading. No loading of individual packages happens at the vehicle. Instead, the Cribs are loaded at the warehouse in an automated 24/7 loading facility called the Load Cell, which is part of this invention. By using a Load Cell and Cribs, both independent of the vehicle, the vehicle is never stuck while being loaded, which would be a big burden on efficiency. This is a key feature of this invention which greatly improves vehicle utilization and driver productivity. The driver never has to waste his time loading the vehicle, or waiting for it to be loaded: the Cribs are already pre-filled with packages at the Load Cell and inserted into the vehicle in seconds.

Instead of 2 Cribs, it is also possible to have only one larger Crib that spans all of the cargo area, or alternatively a higher number of smaller Cribs (such as 3 or 4, for example), depending on what is being delivered and other circumstances.

The Cribs in FIG. 4 have internal divider walls (partitions) such as 36 that create compartments for stacks of packages. These different sized compartments accommodate various sizes and shapes of packaging including, for example, flat padded envelopes, standard boxes sizes, and custom, oversized, or oddly shaped packages. Because stacks of packages can be heavy, especially for oversized compartments, and could potentially crush packages toward the bottom of the stack, horizontal shelves or trays may be inserted into the grid's compartments between smaller groups of stacked packages, if ever needed. The compartment side walls have appropriate holes to insert and support those trays, if ever needed. The vehicle's Telescoping Actuator can install and remove weight reduction trays, if needed. Not needed trays are stored in a tray storage compartment such as 32.

FIG. 4 further shows two standard grid configurations of the Crib's internal divider walls, one for the front Crib 44 (which includes the oversize packages) and another one for the rear Crib 45. The front Crib has a cutout in the front to increase clearance to handle oversized packages, which typically go into the large compartment 41. These grid configurations were designed based in the most commonly used package sizes, but they don't have to be permanent. If there is ever a need to modify that grid configuration, that can be easily done by removing and relocating dividers. The cartesian robot can perform that reconfiguration, either at the Load Cell or in the vehicle. The software will periodically calculate new configurations if it detects potential for improvement and will offer to implement a different configuration, which can then be done by the cartesian robot. The internal wall dividers can be removed and re-inserted in a different location of the Crib by sliding off and into grooves in the Cribs to create different grid possible configurations as needed. That re-configuration of the Crib can be performed automatically by the Load Cell based on the loading algorithm, which proposes a new configuration when the need arises, based on analyzing the information about the packages to be delivered.

A Crib can also have an area dedicated to oversized and oddly shaped packages 41.

A Crib can have a single layer or several layers of oversized packages, with each layer optionally separated by a removable tray. As the vehicle's Telescoping Actuator removes an entire layer of oversized packages for delivery and encounters a tray, it can remove the tray and store it in a tray storage compartment 42.

The height of the oversized area of the front Crib 44 is shorter in the front to provide additional clearance for larger packages to be carried out of the Crib by the vehicle's Telescoping Actuator.

FIG. 4 shows that the Front Crib 41 can be equipped with a sliding front door 47 that slides down to provide even more clearance for especially large packages. The door can be human-hand-actuated, robot-hand-actuated or automated under the control of the RDV's computer control system.

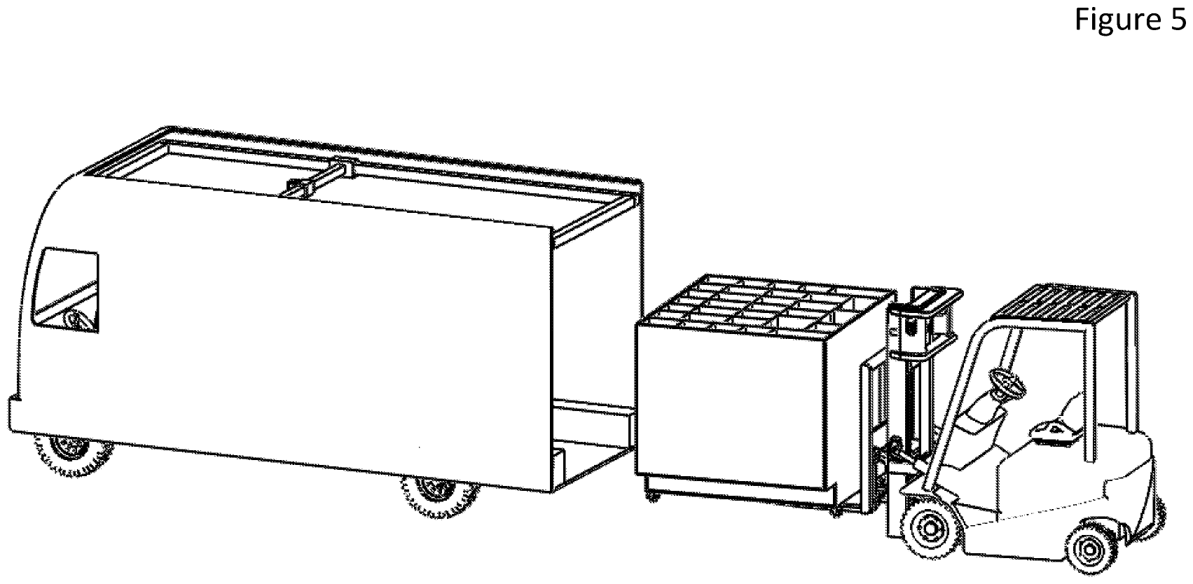

FIG. 5 shows a forklift, which can be a standard forklift or an automated forklift, carrying a Crib which has already been filled with packages at the Load Cell (not shown in this Figure) to insert it into the back of the delivery vehicle.

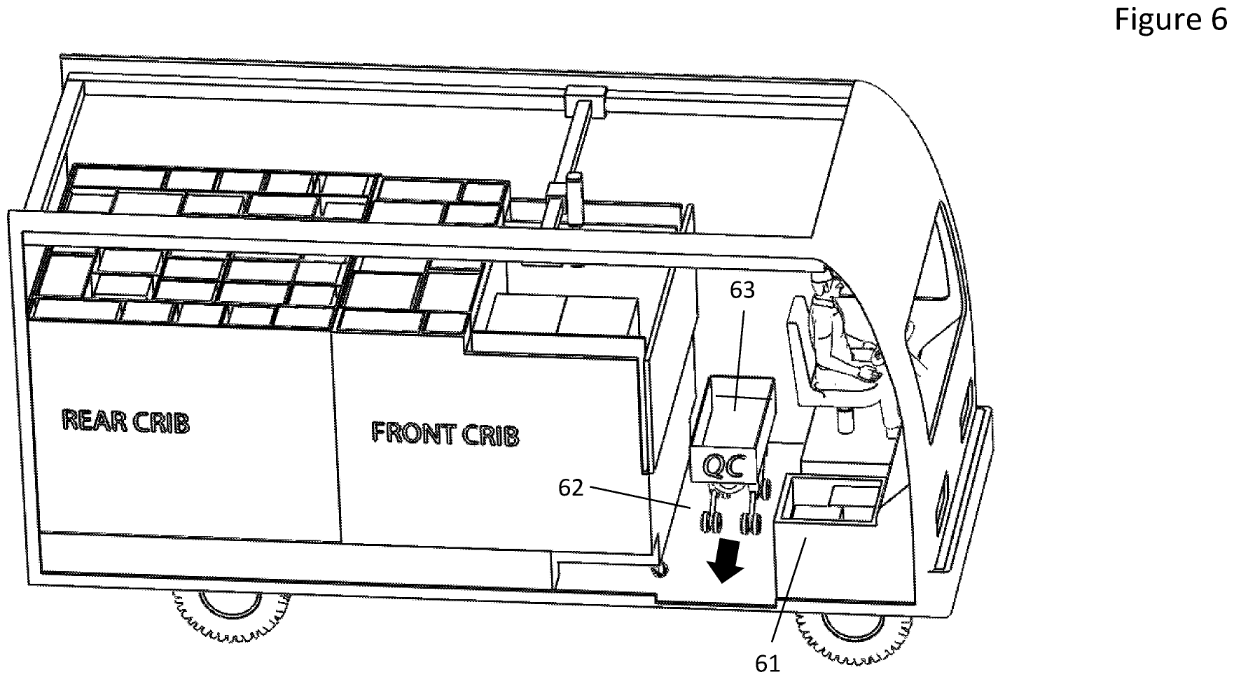

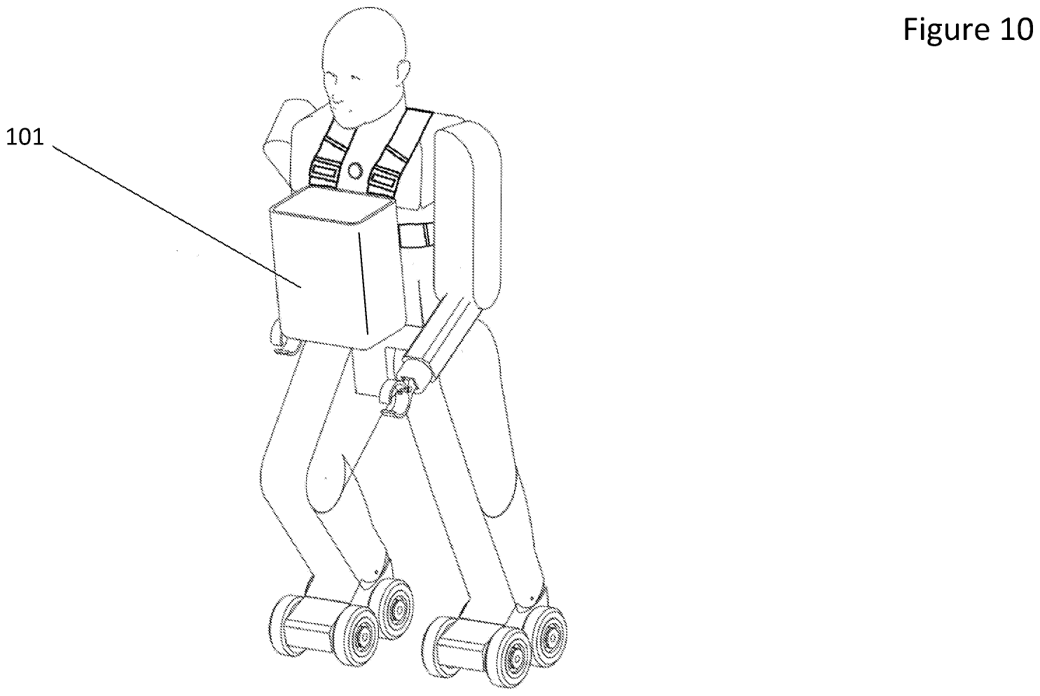

FIG. 6 shows the RDV with two Cribs already inserted into the cargo area of the vehicle. The Cribs are full of packages previously filled into the Cribs at the Load Cell in the warehouse. This Figure shows that the RDV has several staging areas. The staging bin 61 is basically a box that can hold several packages of different sizes and keeps them from falling or sliding across the vehicle. The cartesian robot can deposit packages directly into the staging bin 61. The staging bin 61 is ideally located for either a human driver or a Biped Robot to easily grab the package (s) out of the staging bin and step out of the vehicle through the right-side door (see arrow) to complete the delivery. The staging bin 61 can also be lined by a heavy-duty reusable drop-off bag made of paper, cardboard, plastic, fabric or other suitable material, with carrying straps and a slightly weighted, rigid bottom to keep it open and easy for the driver or a delivery robot to take objects out of it or place objects into it (the drop-off bag used by a robot is shown in FIG. 10).

Another staging area is aisle 62 that starts behind the driver's seat and extends all the way across the vehicle to the right-side door. The area 62 behind the driver is ideal for a quadruped robot (labeled QC for quadruped carrier) to wait for packages to be loaded directly into the QC's top bin 63 by the Telescoping Actuator, so when the vehicle arrives at the next stop, the robot can immediately move across aisle 62 and exit the vehicle.

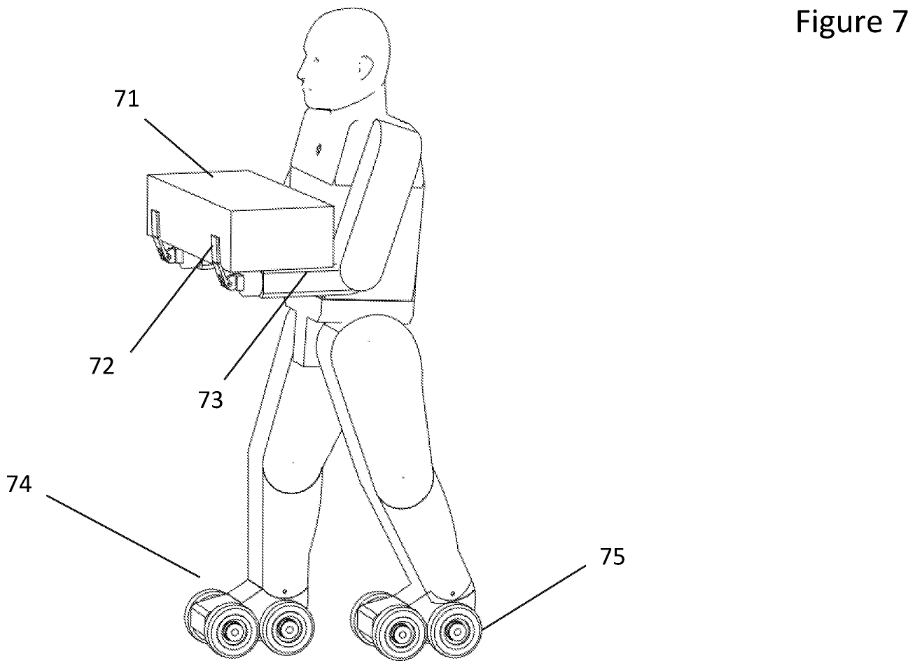

FIG. 7 shows a side view of our biped delivery robot carrying a package 71, by resting it on the flat areas of its forearms 73 and supporting it frontally with the special grippers 72 designed for that purpose. This arrangement creates a cradle where the package is contained and can be securely transported by the robot.

This robot also has a significant innovation in its locomotion method. The problem with locomotion of biped robots in general until now has been that their walking is a constant struggle to maintain balance, with every step creating an unstable situation that can and sometimes leads to falls with potential damage to anything nearby including people and property. The control system of the robot has to constantly evaluate and re-evaluate if the robot is stable, many times a second, and trigger corrective action if a fall becomes likely or imminent because of changes in the terrain, obstacles in the way, stairs, and many other largely unpredictable occurrences. Conventional robots can walk and even jump, but generally at relatively low speed, with high energy consumption and with a significant probability of falls.

The novel biped robot of this invention addresses those issues with the special robot feet 74 that include a plurality of motorized rollers 75 each, with typically four rollers per foot as shown in FIG. 7 (or at least two extra wide rollers for each foot, one in the front and the other one in the rear of the foot). The robot acquires therefore the capability to either roll on the motorized rollers, which provides sufficient speed for a fast delivery, or to walk on the rollers, in which case brakes are applied to all the rollers, preventing them from turning and thus becoming a stable sustaining base for the robot. The rollers can have a layer of rubber or other anti-slip material that will increase stability and safety.

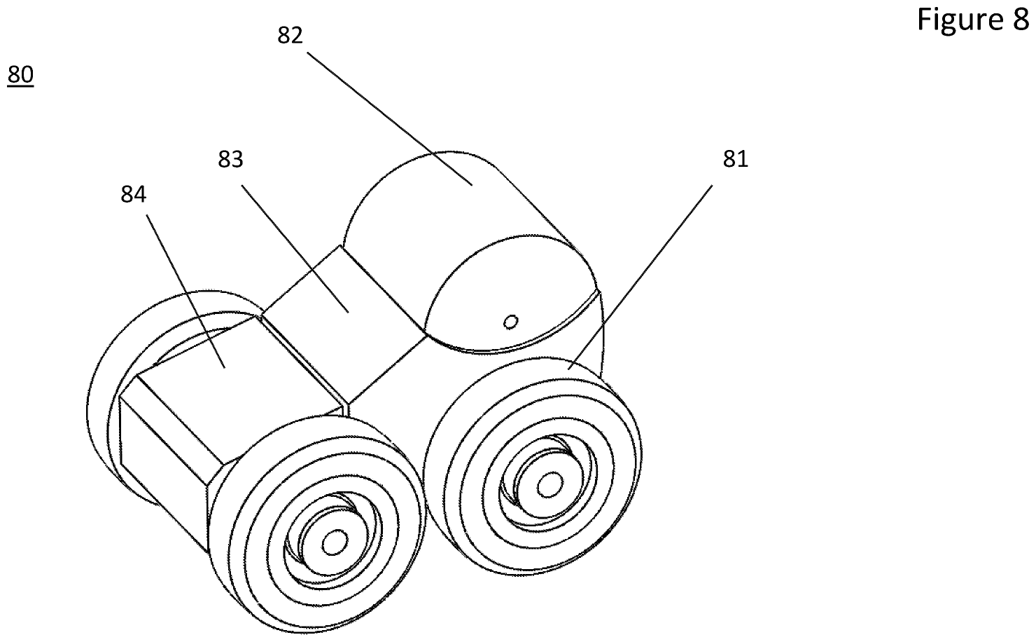

FIG. 8 shows one of the special robot feet. Each foot 80 consists of a number of motorized rollers 81, a pivot portion 82 that connects the foot to the lower leg of the robot, a rear foot portion 83 and a front foot portion 84.

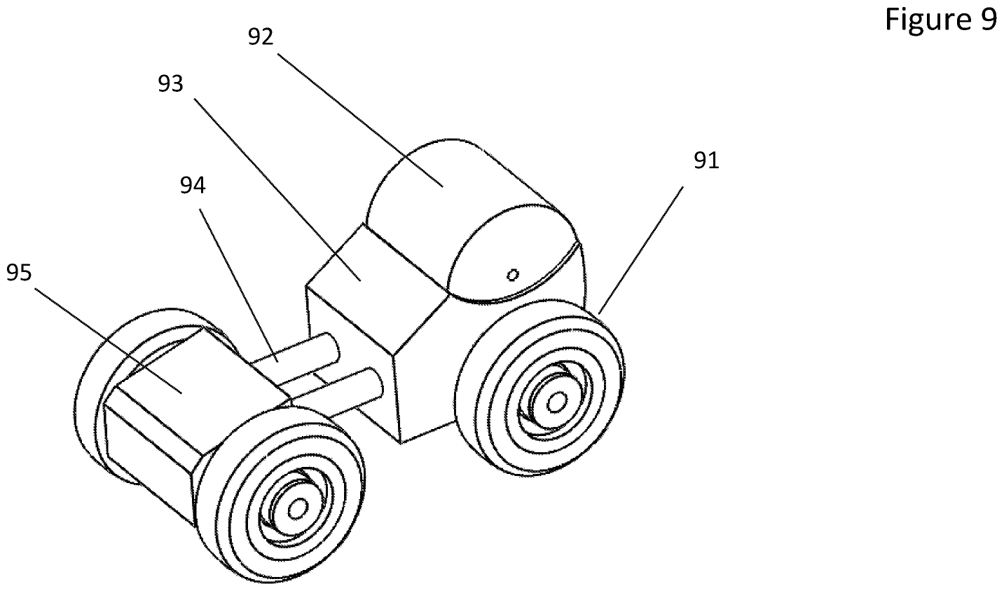

FIG. 9 shows one of the special robot feet in extended position, wherein the front portion of the foot 95 has separated a significant distance from the rear portion of the foot 93, by virtue of the extension rods 94, which can be threaded into the front portion 95 and turned by a motor in the rear portion 93, causing a linear displacement of the front portion when the motor turns. The result is a substantial increase in the length of the foot, which increases stability and enables robot rolling locomotion at a substantially higher speed than walking, with low energy consumption. If the terrain becomes inadequate for rolling locomotion, the robot can recognize that with its machine vision capabilities and it retracts the front portion of its feet, reducing feet length to a length more suitable for a walking gait that he robot has been trained for. This is also essential for stairs climbing, which is difficult with extended feet.

The expansion of the feet to increase stability can also be applied laterally with a similar mechanism, or by just extending the shafts of the motorized rollers and therefore growing the lateral distance between wheels on the same foot, or other methods to implement this invention.

This above disclosed hybrid type of robotic locomotion with adjustable feet is not limited to package delivery robots, it is actually a new general type of locomotion that will generally benefit robotics in many applications. It overcomes the issues of speed, instability, safety and high energy consumption, and it renders a robot with better locomotion capabilities on different terrains.

FIG. 10 shows the novel biped robot with the previously described Drop-off Bag 101. The Cartesian Robot can also drop packages directly into the Bag 101, which is ideal when there are too many packages in a route stop to comfortably handle in a human's or biped arms. The Robotic Delivery Bag can be worn on the chest of the Biped Robot with appropriate adjustable straps, leaving his arms free, which is useful if there is a need to open/close doors or pick up other objects. The slightly weighted rigid bottom makes the Robotic Delivery Bag easy for either a human or biped robot to re-insert the bag into the staging bin upon returning to the vehicle after completing a delivery. It is also possible for the cartesian robot in the RDV to insert or extract packages directly into or from the biped robot's bag. Instead of adjustable straps, the Bag 101 can be held in place by other mechanisms such as mating hooks, cylindrical pins into mating holes and other.

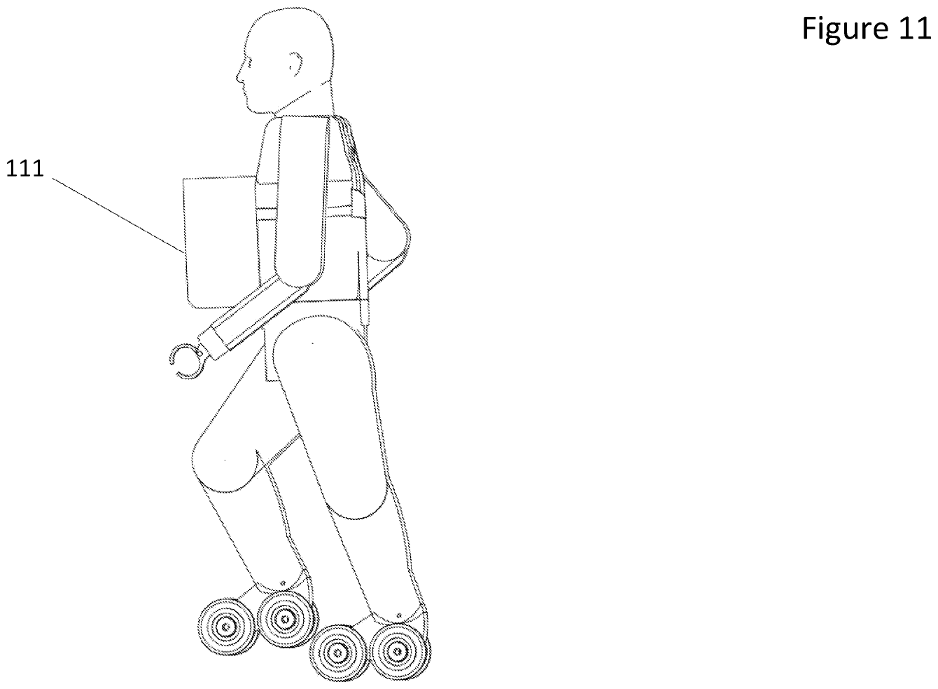

FIG. 11 shows a side view of the biped robot using the Robot Delivery Bag 111 to deliver packages to a customer door.

The present invention can be used in different modes of operation, with varying degrees of automation. These different modes are shown and described below:

### Mode 1: Human Driver

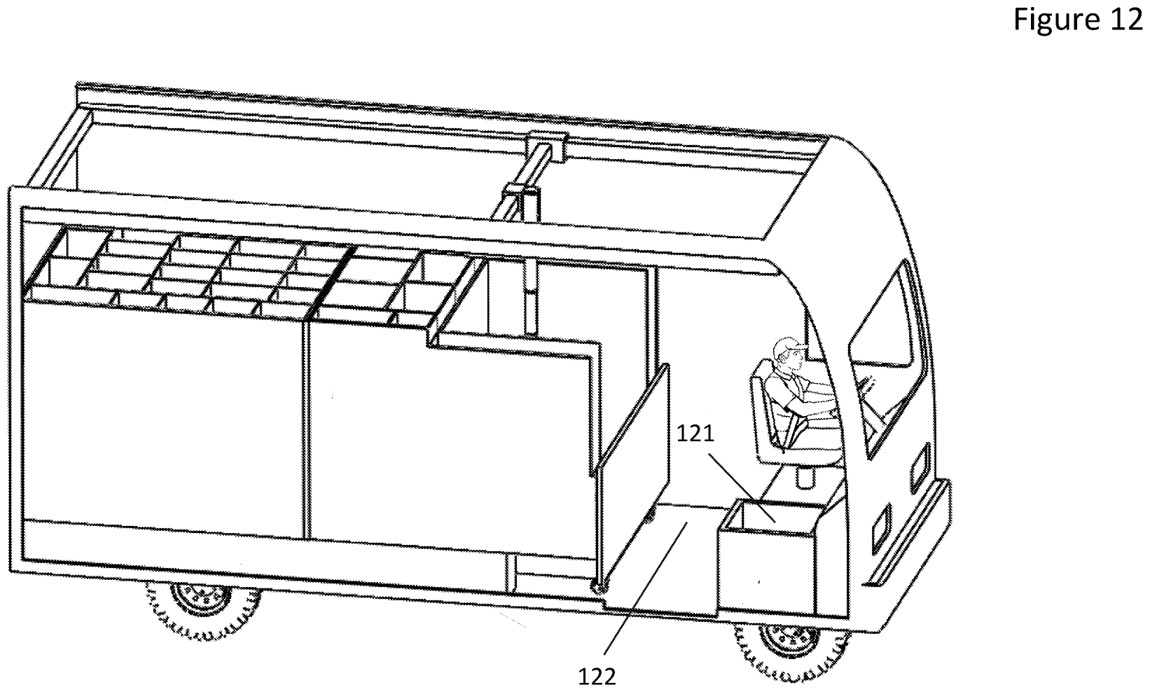

As shown in FIG. 12, in this mode the vehicle is driven by a human driver, who also delivers the packages to the customer doors. The driver is assisted by the cartesian robot, who puts the items to be delivered at the next stop in staging bin 121, and the oversized packages for that destination in aisle 122, behind the driver's seat. Everything is ready to drop off upon arrival. The driver never needs to load the vehicle, sort packages or search in the cargo area, killing efficiency. Everything is ready upon arrival at the next stop, leading to major productivity gains. With this invention, a human driver can become highly efficient. Another major advantage of this mode of operation is that it can be implemented immediately, without waiting potentially for many years until self-driving vehicles are approved (or not approved).

### Mode 2: Human Driver Assisted by QC (Quadruped Carrier)

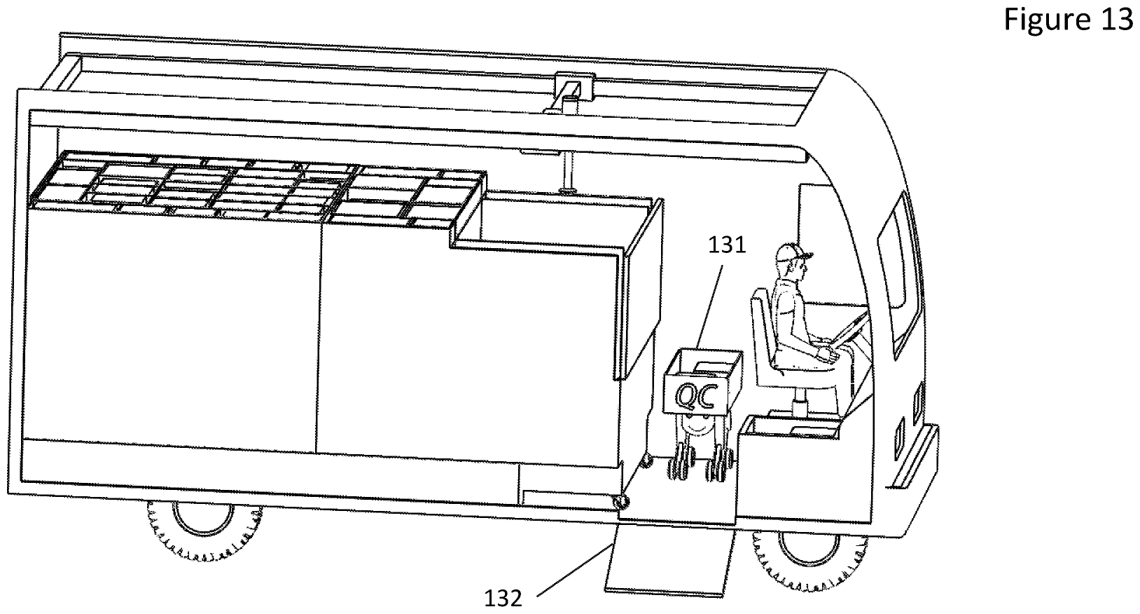

As shown in FIG. 13, while the human driver drives the vehicle to the next destination, the cartesian robot deposits the packages for the next stop into the staging bin of the quadruped carrier (QC) 131 sitting behind the driver's seat. When the vehicle stops, the QC immediately exits the vehicle using an automatically deployed ramp 132. The Quadruped Carrier of this invention has unique innovative features that make this mode possible and extremely efficient. Those features are described in detail herein below.

An advantage of this arrangement is that the driver can double park in certain cases if necessary, in areas where parking is difficult, and the robot comes back swiftly so the vehicle can quickly move on, avoiding traffic congestion. The driver can also drive around the block while the robot delivers and come back to pick up the delivery robot.

Mode 3: Human Driver with Biped Robot Assistant

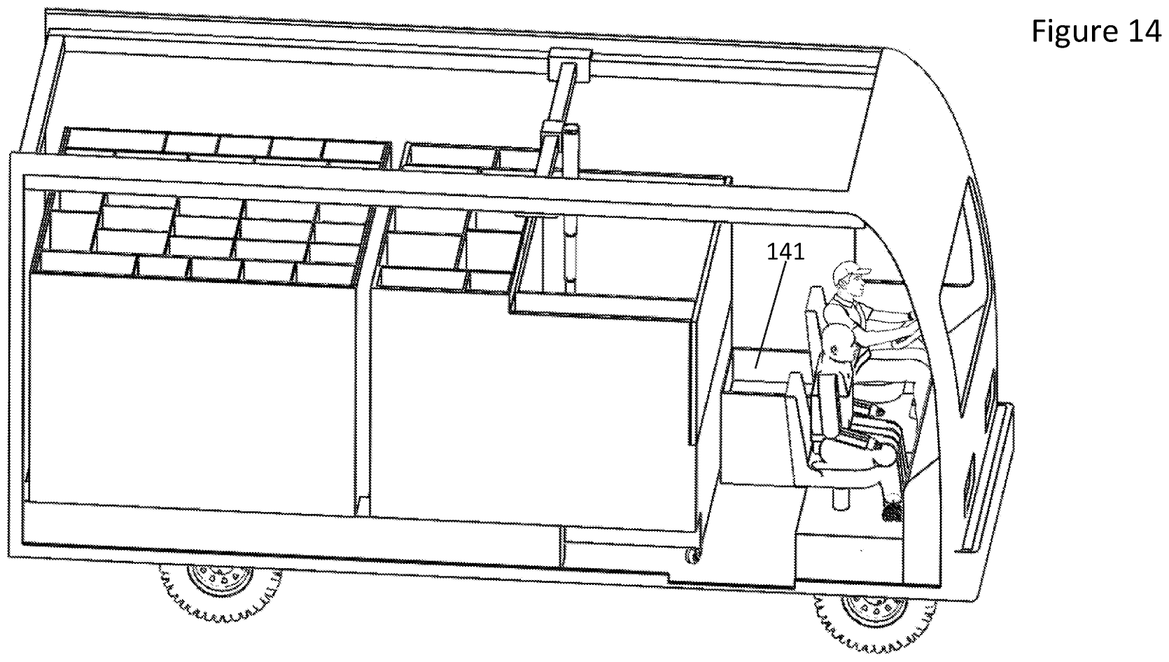

As shown in FIG. 14, the human driver drives the vehicle while the biped robot is sitting on the passenger seat. While the human driver drives, the cartesian robot puts the next delivery batch in the staging bin 141. Upon arrival, the biped robot grabs the items to be delivered from the staging bin 141, exists the vehicle, drops off the package (s) at the customer door and rushes back to the vehicle. The driver waits in the vehicle, or optionally could help deliver in some cases, such as a destination with multiple packages. The driver can double-park in certain cases, if necessary in certain areas, and the robot comes swiftly back so the vehicle can move on, avoiding traffic congestion. The driver can also drive around the block while the robot delivers and come back to get the robot. It's a team in action (human driver plus biped delivery robot).

### Mode 4: Human Driver Assisted by Two Last Yard Delivery Robots

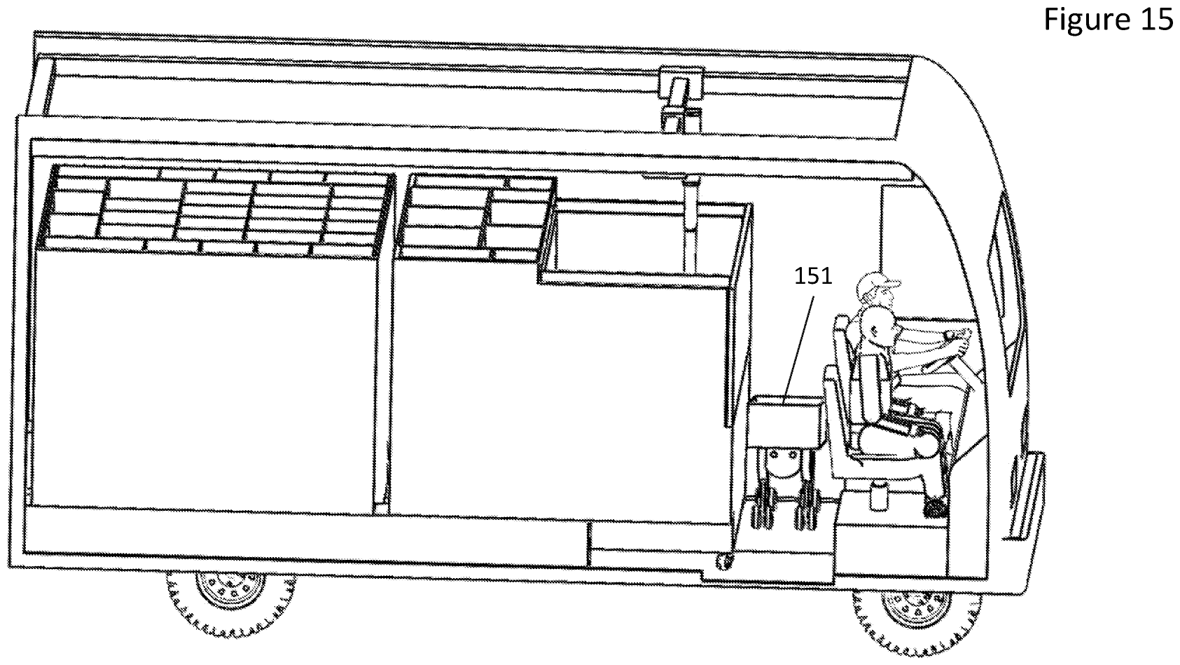

As shown in FIG. 15, the biped robot sits on the passenger seat, and the quadruped robot sits behind the driver's seat. The computer of the cartesian system picks up the packages for both of them from the cargo area. The QC's top bin 151 can be used as a staging area for both robots. This bin has at least 2 compartments, which are used to separate the packages for the biped from the packages for the QC. The algorithm of the cartesian robot has the information and decision rules to assign packages to both robots according to what they are best suitable for. If there are stairs to climb, the biped robot may be more suitable for a certain package. For heavy objects, the quadruped may be better suited because of its wheels and extremely stable architecture. If doors need to be opened and closed, or delivered to boxes or slots that may be located at a certain height from the floor, the biped may be more suitable. The combination of these two robots covers basically every conceivable situation.

Mode 5: Self-driven vehicle with last yard delivery robot

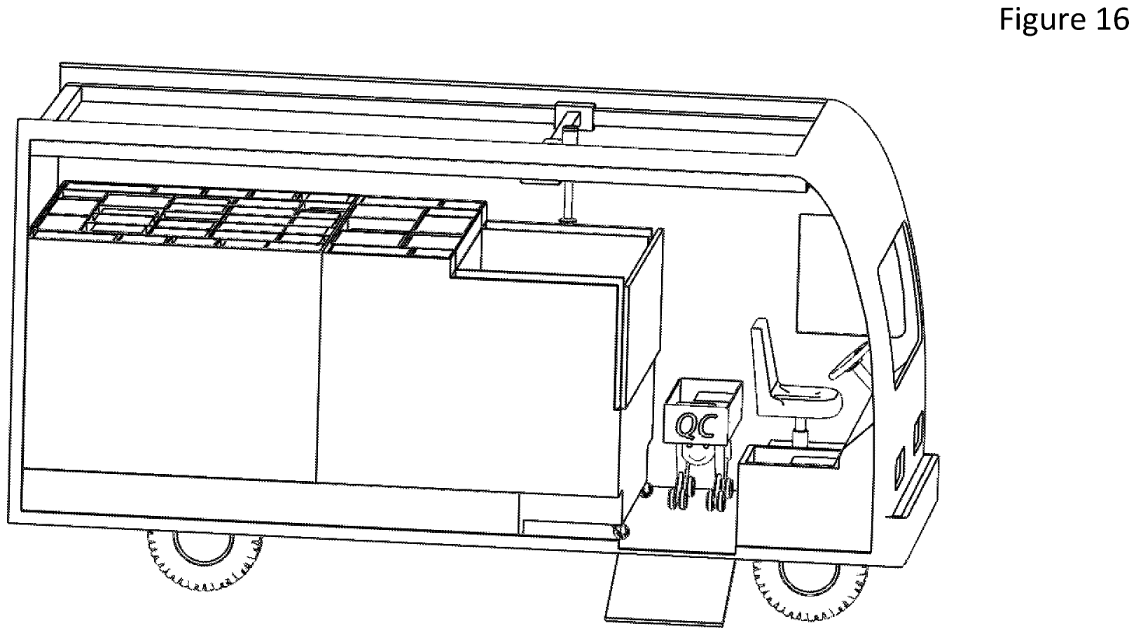

Once self-driving is finally approved and legal, this invention will provide the perfectly structured and organized environment required for automated delivery. FIG. 16 shows the vehicle being operated in self-driving mode (no human driver). Upon arrival, the delivery robot, the QC in this Figure, exits the vehicle with the packages and performs the drop off.

Mode 6: Self-Driving Vehicle with Two Robots

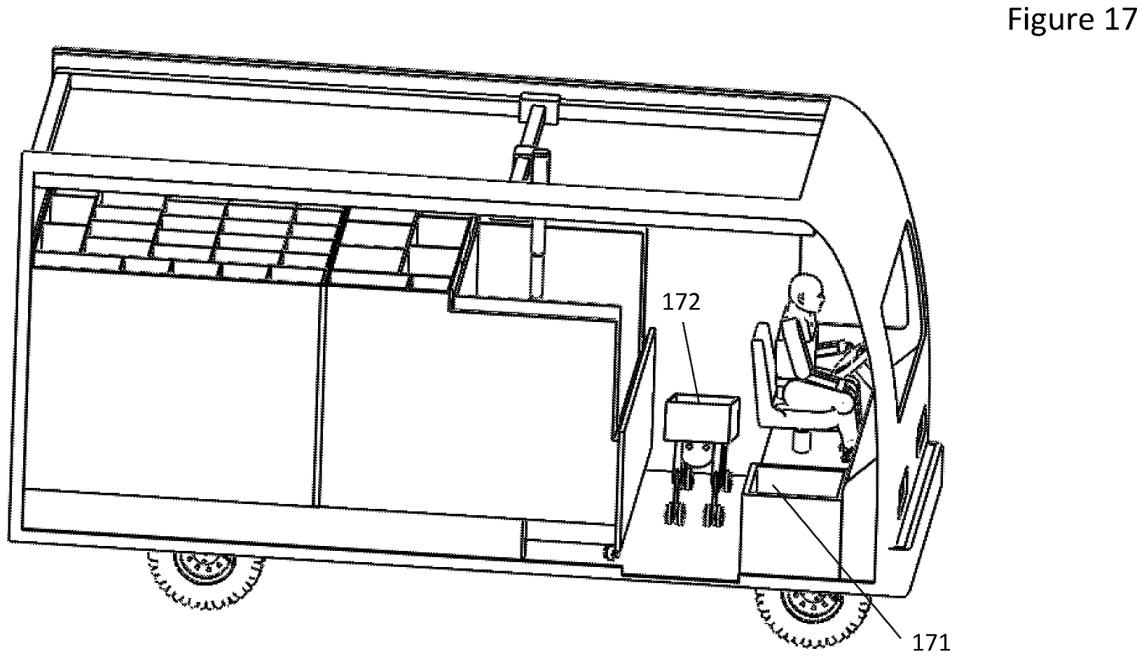

As shown in FIG. 17, the vehicle is in self-drive mode (no human driver). The biped robot sits in the driver's seat, while the quadruped robot sits behind the driver's seat. The packages for the biped robot are deposited by the cartesian robot in the staging area 171, while the packages for the quadruped robot are deposited by the cartesian robot in the quadruped's bin 172. The computer algorithm makes the assignments according to the best fit. Upon arrival at the destination, both robots simultaneously perform their deliveries. This is an extremely efficient mode of operation. It has the additional advantage that the presence of the biped robot on the driver's side could allay the fears of humans regarding a self-driving vehicle, even if the robot is just using that seat for sitting purposes and not really driving. Additionally, the presence of the robot on the driver's seat will probably discourage the temptation to try to rob from the vehicle.

7. Other modes of operation (not depicted) include a vehicle being driven by a trained driver robot, who physically operates the steering wheel and the normal controls of the vehicle (which can be a self-driving vehicle that can be overridden by the trained robot, or a non-self-driving vehicle), with the deliveries being performed by the driver robot upon arrival, or by a robot assistant, or by both simultaneously.

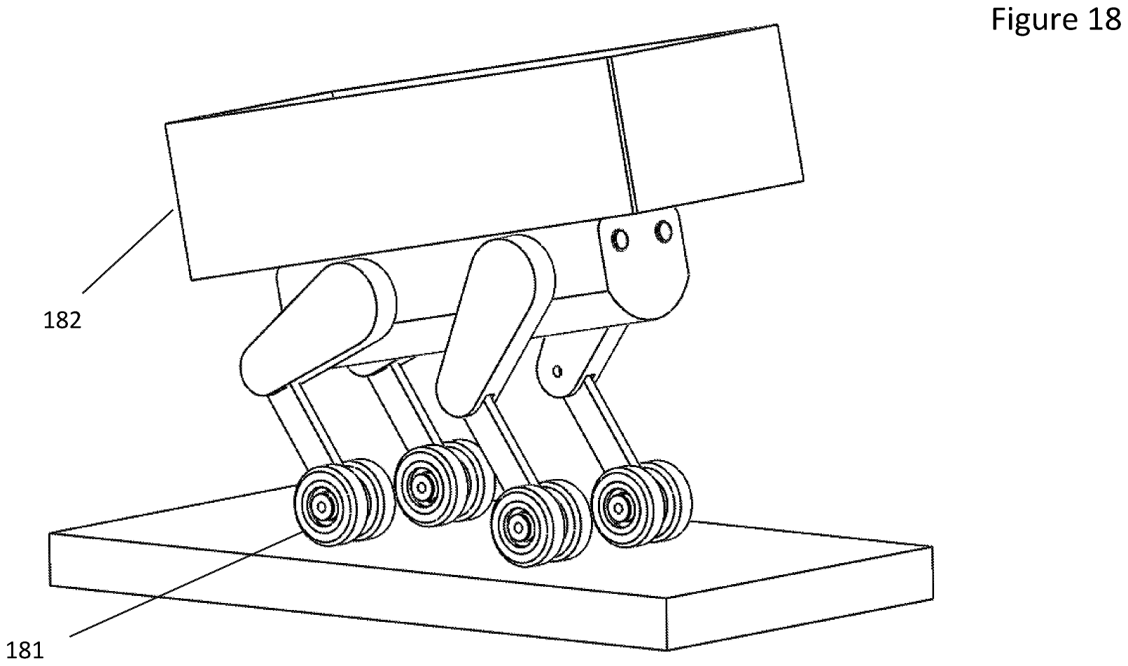

FIG. 18 shows the Quadruped Carrier (QC). The four pairs of motorized rollers 181 provide the ability to travel at relatively high speed with low battery consumption on normally flat surfaces such as streets, pavements, sidewalks, yards, walkways and driveways (the most typical delivery areas), but also with the ability to lock the wheels and use them as feet to walk on more difficult terrain, overcome obstacles and climb stairs. The Quadruped Carrier has a staging bin 182 located on top of the robot body for holding packages. The vehicle's cartesian robot can deposit packages directly into this bin while the vehicle is on its way to the next route stop, so upon arrival the QC will be ready to drop off the packages at the customer door. The bin can have an open top or be fully enclosed with an optional top-cover that closes after packages have been loaded into it for safety and privacy.

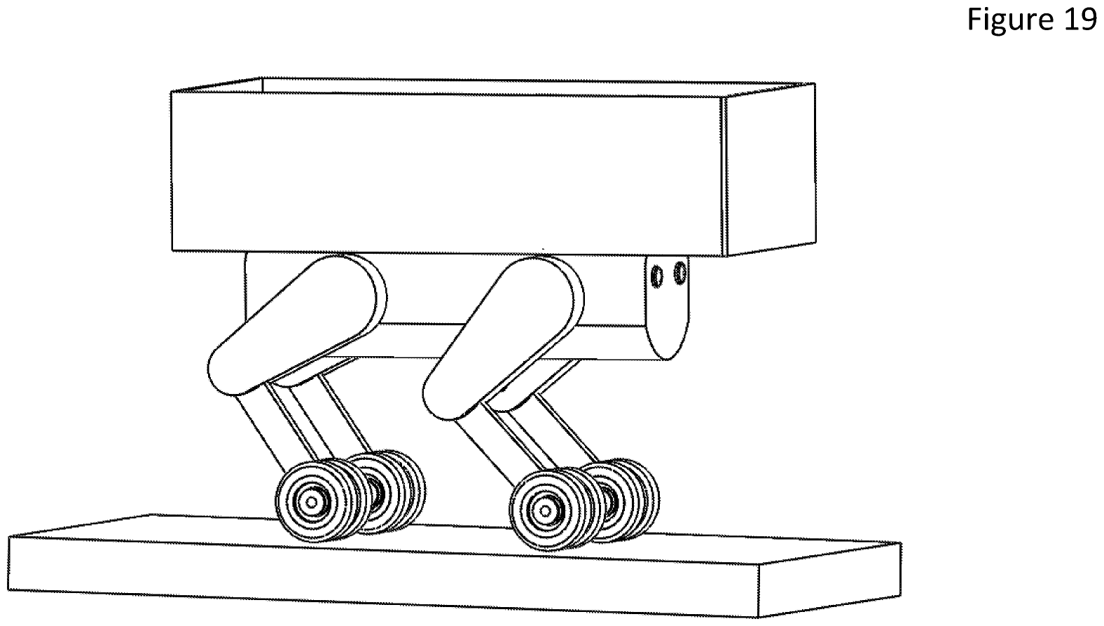

FIG. 19 shows the QC traveling from the robotic vehicle to the customer door. If there are stairs, toys, vehicles, plants, pets, people or any obstacles in its way, the QC would become instantly aware of it through its machine vision capabilities with multiple cameras, and it would instantly switch to a walking mode, locking the rollers and entering into an appropriate gait (which are programmed into the QC's algorithm with extensive training). If it encounters people it could politely greet them and announce the purpose of its visit (“Good morning. Delivering an order”).

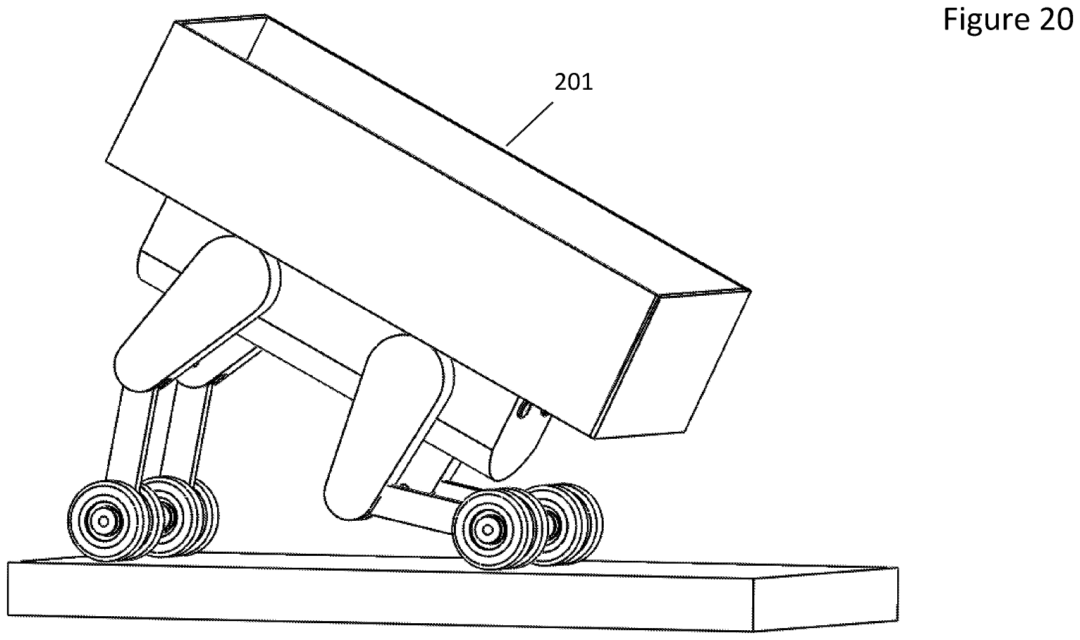

FIG. 20 shows QC performing the drop-off. When QC arrives at the drop-off point, it stops and then goes into an inclined position to complete the drop-off. To do that, QC bends its front legs down to lower the front of the staging bin 201 and extends its rear legs to raise the rear of the bin, creating an angled position.

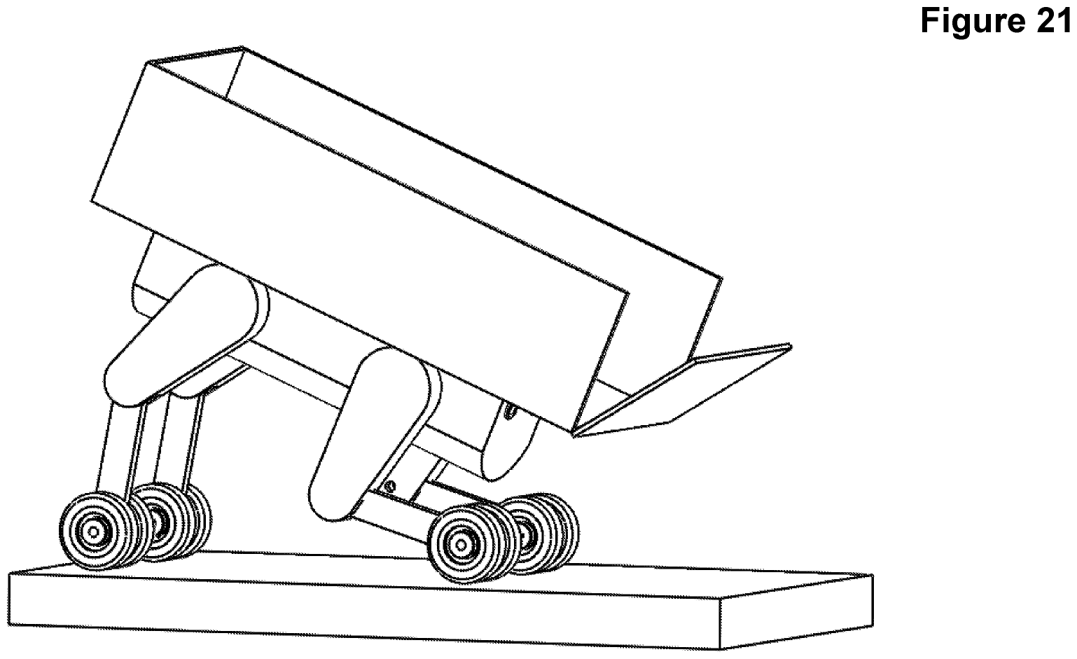

FIG. 21 shows that the Quadruped's bin has a front-lid that opens and pivots toward the ground. In FIG. 21 the lid is just beginning to open. The lid can be opened just by electrically releasing a stop and allowing the bin to come down by gravity, with a retarding mechanism such as a friction hinge or a small air cylinder to avoid an abrupt deployment. It can also be motorized both ways (up and down).

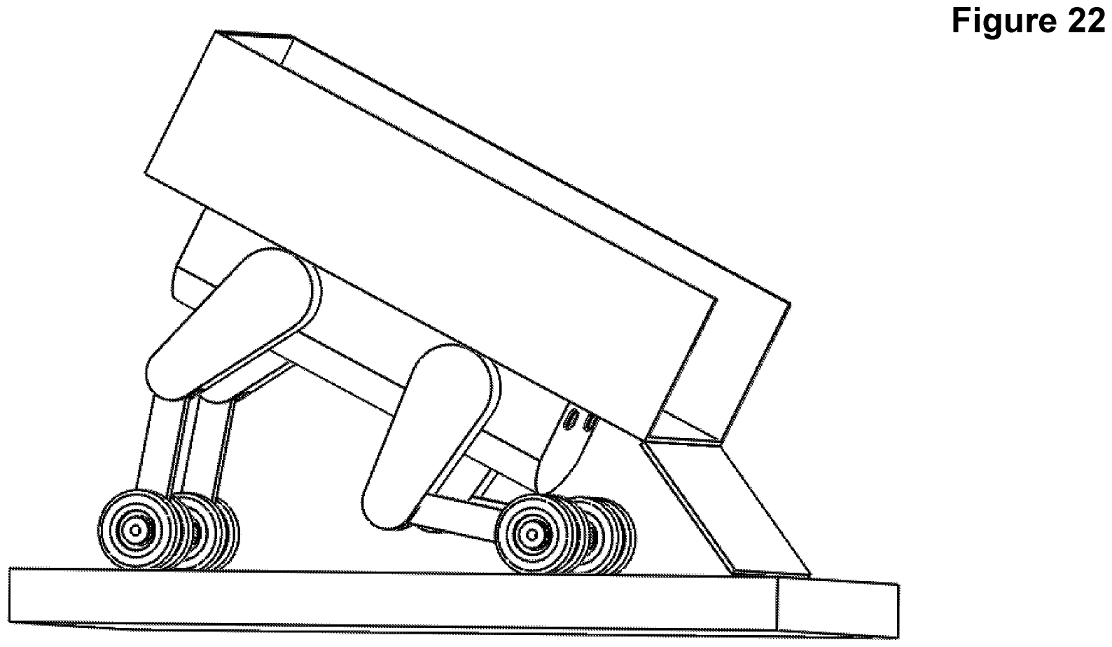

FIG. 22 shows the ramp completely deployed, with its lower edge resting on the ground. The lid acts as a ramp that allows the package to slide out for delivery. The package slides down by gravity. The QC then backs up a small distance to completely separate from the package, closes its front-lid, adjusts its leg position for rolling or walking mode, scans the package to record the delivery and photographs the delivery. The front-lid can optionally be equipped with a small roller attached to the front edge to facilitate backing up without scraping the floor.

The above described drop-off method is the preferred drop-off method in this invention for the last yard delivery robot, because of low complexity, high reliability and low cost. The invention includes other embodiments that can make sense for certain types of loads and other circumstances, such as lateral drop-off, where the bin tilts sideways to unload its cargo. It is also possible to replace or supplement gravity by installing a pushing actuators in the bin to unload the cargo. A vibrating motion can be created if the package (s) for some reason do not slide off easily from the bin. All these additional embodiments and features are an integral part of this invention.

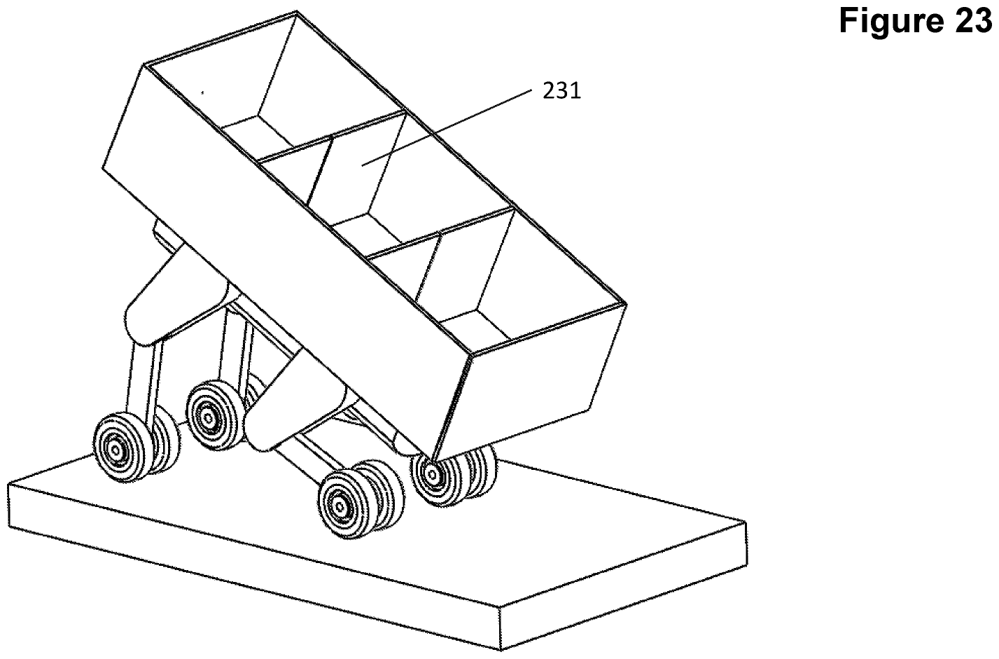

FIG. 23 shows another embodiment of the Quadruped Carrier, which allows the QC to carry a number of orders for different customers at nearby locations in its bin, without having to go back to the vehicle to get more packages after each drop-off. For that purpose the bin is equipped with divider walls such as 231, dividing the bin into a number of compartments (in this Figure there are three such compartments as an example, but the quad carrier of this invention can be equipped with any reasonable number of compartments). The vehicle's Cartesian Robot loads all packages into these compartments in the optimal sequence according to addresses, with the first delivery stop located closest to the front door and the last delivery stop located farthest from the front door. The compartments separate packages going to different addresses. If an address has too many packages to fit into one compartment, the vehicle's Telescoping Actuator can load them into adjacent compartments, so they all get delivered to the same address.

The Qc can have a top-lid (not depicted in the Figures) to provide privacy, deter theft and protect from the elements.

The Quadruped's top-lid, front-lid, and divider doors are under the control of the Quadruped's computer. They are electrically actuated or by other means. When required, all of the divider doors can be closed to create one large bin for larger packages or for situations when a delivery address includes a large number of packages.

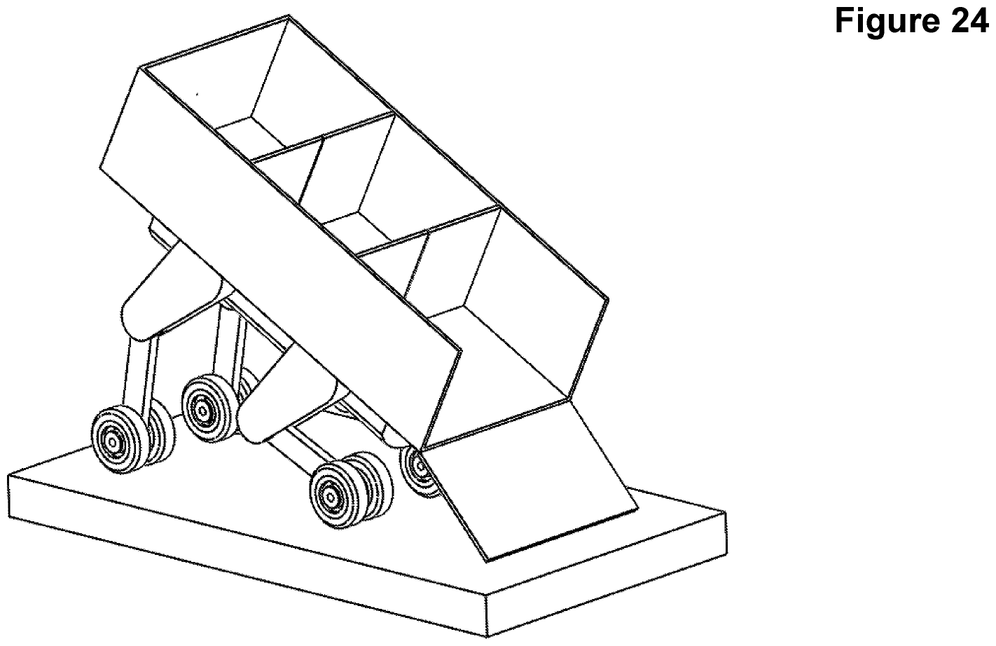

FIG. 24 shows QC at its first stop, taking inclined drop-off position, opening its front lid, then delivering the packages contained in the front compartment.

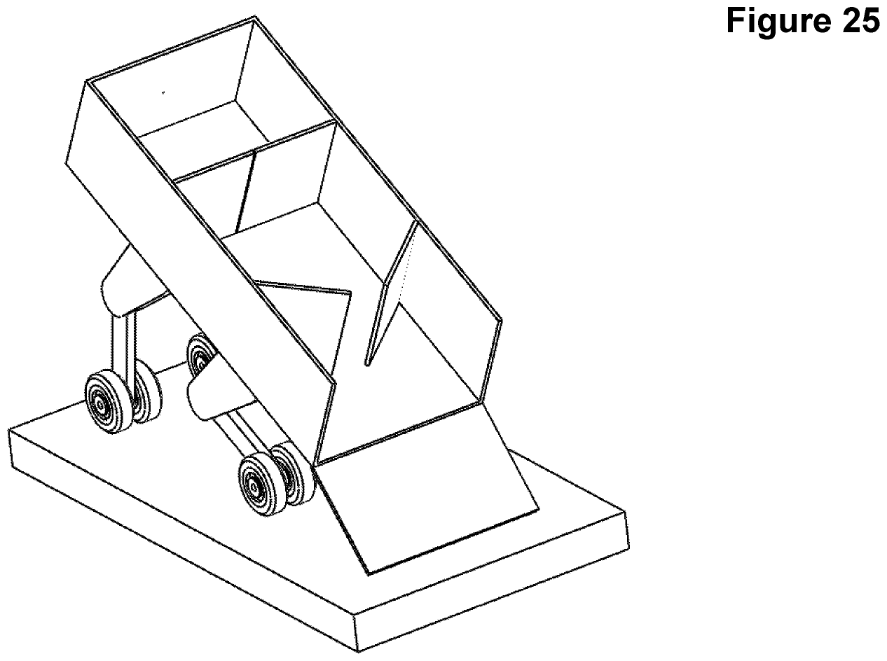

FIG. 25 shows QC at its second stop, taking inclined drop-off position, opening its front lid, opening the doors to the central compartment and about to drop-off the packages contained in the central compartment.

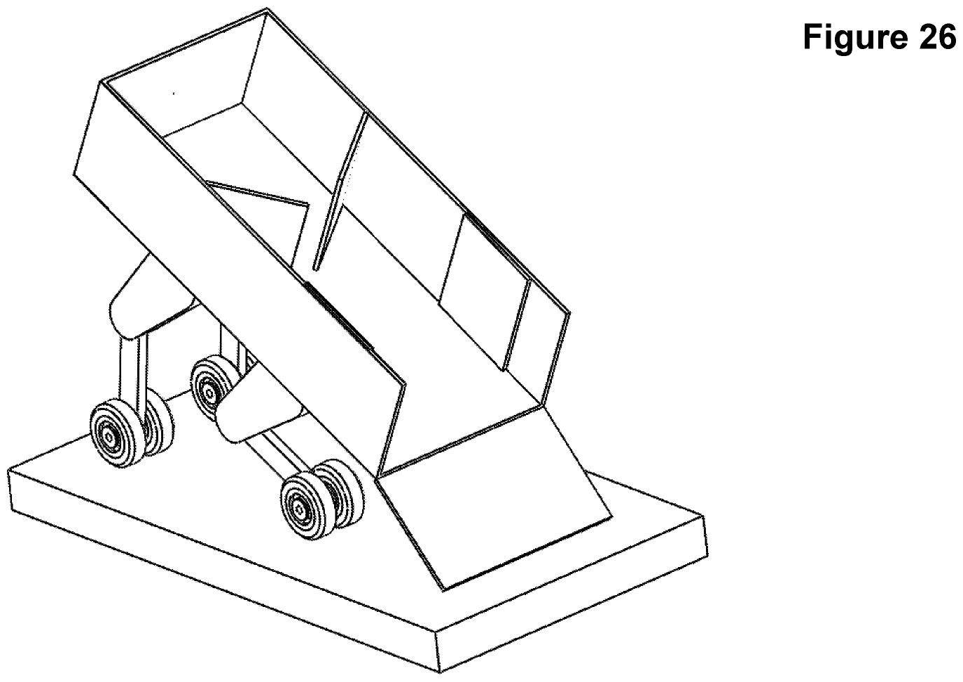

Finally, FIG. 26 shows that at the third delivery stop, QC opens the final set of divider doors and delivers the content of the rear compartment.

Intermediate divider doors can be kept closed initially and opened sequentially, not all at the same time, to prevent the load from upper compartments from gaining too much speed in their descent and potentially cause damage to goods. That way the goods descend gradually and sequentially from divider-door to divider-door in their descent.

This novel Quadruped Delivery System can deliver and drop off packages without any human intervention, and without requiring the presence and/or assistance from the customer or any other source.

In addition, this invention includes numerous other embodiments with other methods to separate the content of Quadruped's bin according to different delivery addresses, size, weight, or other criteria, by using systems such as proximity sensors, machine vision, photocells, rollers, gates, use of a robotic arm in or near the bin to scan, sort, search, relocate, reorganize, extract and deliver envelopes and packages.

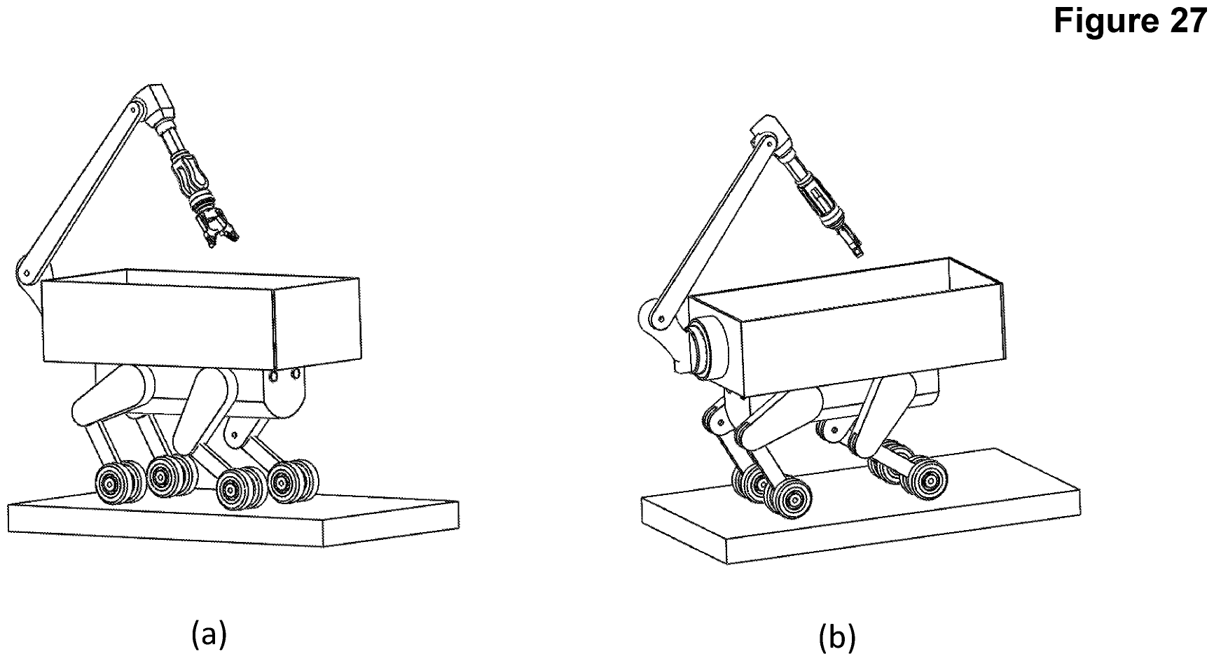

FIG. 27 (a) is a side view of the QC equipped with a robotic arm, which can be used to open and close doors, deposit envelopes and packages into delivery boxes or counters or in some cases people and over a box or envelope to somebody waiting for delivery. The QC has the ability to quickly retool itself with a different type of gripper at the end of the arm if necessary to handle a special situation. FIG. 27 (b) shows a rear view of the QC with a robotic arm.

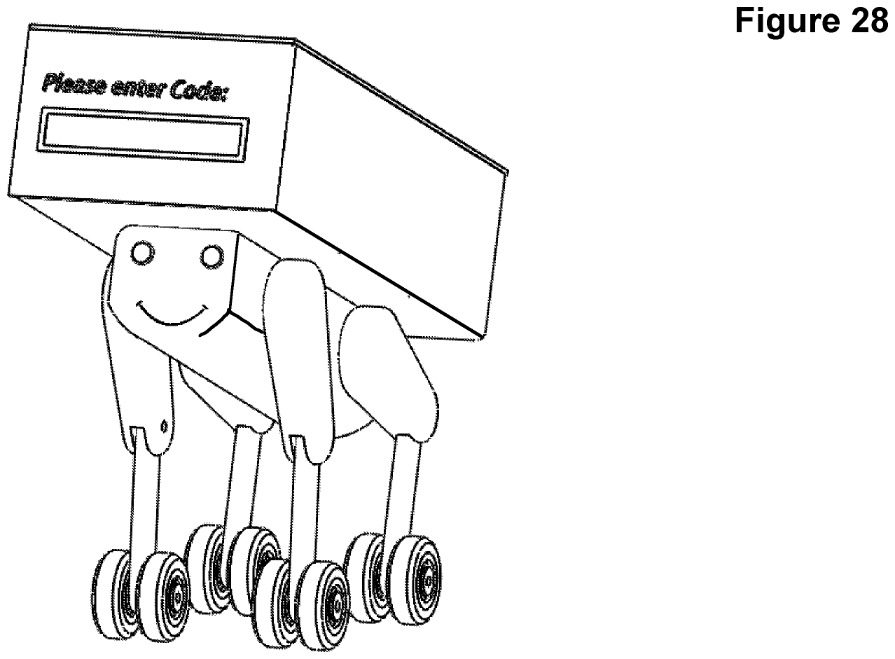

FIG. 28 shows the QC with a touch-sensitive screen in its front lid, which can be used by a recipient to identify him/herself with a code to unlock the top cover of the QC (or a section thereof), and gain access to retrieve an envelope or package from the top bin (or a compartment thereof). This feature is useful for envelopes or packages that require a recipient's signature for delivery, such as some Fedex or UPS deliveries. The user can sign on the touch-sensitive screen. The front screen can also be used for credit card payments if necessary, and the QC can photograph the user for additional safety (if user grants permission).

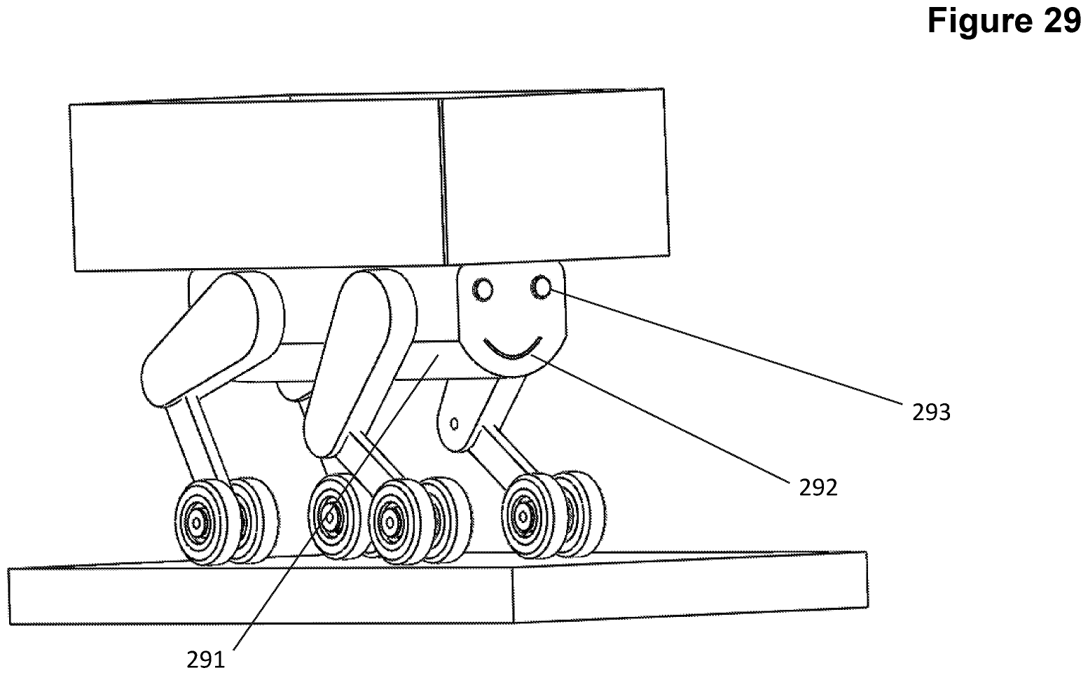

FIG. 29 shows the friendly appearance of the QC robot. This is a very important and practical feature. The usefulness of a robot system depends largely on the acceptance by humans, who tend to instinctively mistrust robots and sometimes see them as a potential threat or danger. Therefore it is important to give the robot a friendly appearance so it can accomplish its mission, especially considering that it will have to enter the areas where humans and their families live. Upon encountering people and recognizing them as such, which is a basic capability available through machine learning, the QC robot should politely greet and announce what it is doing (“Good morning. I'm delivering an order”). For children, who are also easy to recognize by the QC robot, there will be a less formal, even friendlier greeting (“Hi, I'm QC. I'm just delivering a package. Hope you are having a fun day!”). Friendly attitude and friendly appearance are very important in order not to scare or puzzle people when entering their property, and it is an important part of the customer experience. QC should not instill fear or mistrust, it should actually astound people with its friendliness and fascinate them with the wonders of technology. QC has been designed with a rounded shape 291 in the lower portion of its body simulating the shape of a face. The face has two cameras 293 simulating eyes, and an optional curved slot 292 under the eyes simulating a smile. The slot is used also as the outlet for the speaker's sound.

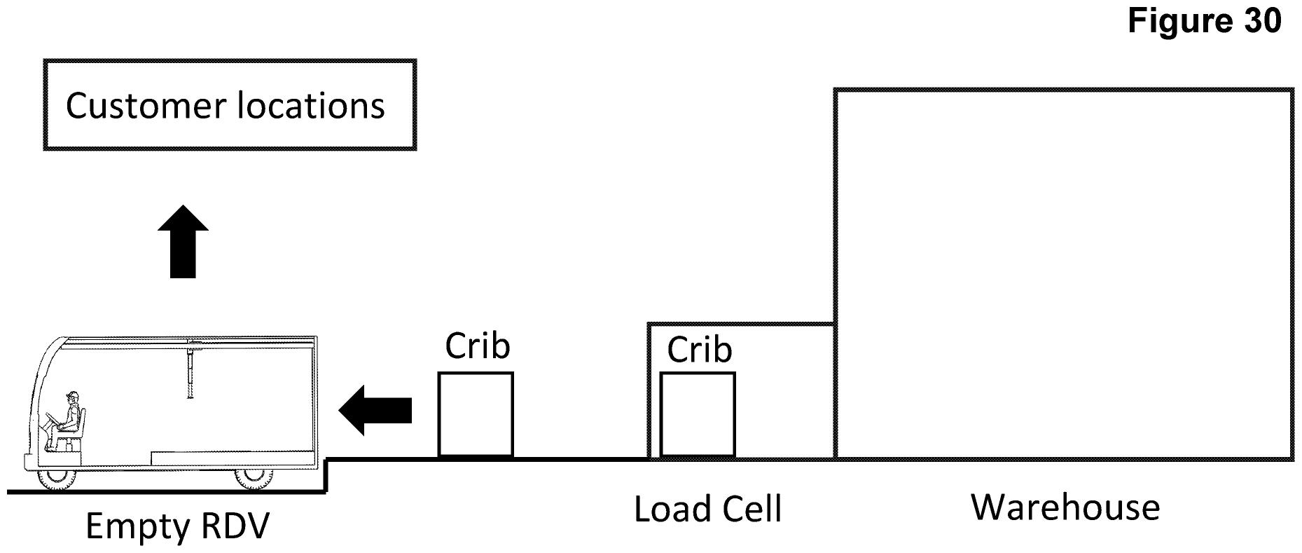

FIG. 30 shows a diagram of the complete robotics package delivery system of this invention, from the Load Cell attached to the warehouse (where the Cribs are filled with packages) to the RDV and then to the customers. This process will be described in detail in the following figures.

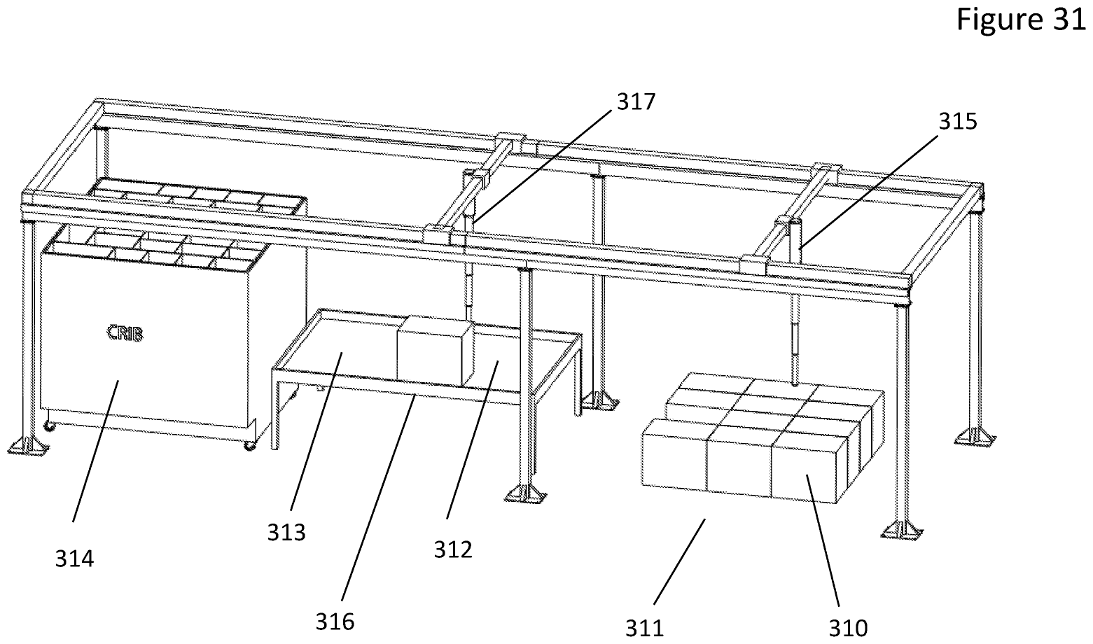

FIG. 31 focuses on the Load Cell, which can be attached to the warehouse, near or even inside it. The loading process takes place in several steps:

Step 1: the process begins with the arrival of bags such as 310 coming from the warehouse/distribution center. The bags contain the packages to be delivered. These bags were filled at the distribution center in order of delivery sequence for efficient routing, so each bag has a delivery rank scannable from the bag.

Step 2: the cartesian robot 315 scans the bags' identifying barcodes in the incoming area 311 of the cell, locates which bag comes next in route order, picks up that bag with its Telescoping Actuator and deposits it on the sorting table 316, between sorting areas 312 and 313. Bags are picked up in reverse route order so that when loading a Crib, the packages that are to be delivered last in the route are loaded into the Crib first (LIFO strategy).

Step 3: the Cartesian Robot 315 empties the contents of the current bag (typically 10 to thirty packages) into Sorting Area 312. The Robot Actuator 315 then lays all packages flat and orients them so that barcodes or other identifying stickers are facing upward, visible to the robot Actuator scanner.

Step 4: In the next step, the Robot Actuator 317 moves each package from Sorting Area 312 to Sorting Area 313, placing them into precise route order. Cartesian robots like 315 and 317 are extremely efficient at such sorting tasks, much faster than a human worker can possibly be and with an extremely high level of accuracy.

Step 5: Next the algorithm assigns each sorted package a particular position in the Crib 314 according to route order and package size/shape/weight. Specifically, the algorithm ensures that packages are stored in route order so that packages to be delivered last are stored near the bottom the Crib and packages to be delivered first are stored near the top of Crib. The Software also assigns packages a specific compartment size that is large enough to accommodate the package while at the same time tight enough to ensure packages do not shift or fall out of order when stored as stack in the compartment. The routing sequence must be preserved and cannot be disturbed by shifting or shuffling due to vehicle movement. The different size compartments ensure that.

Step 6: Robot 317 moves the sorted packages from Sorting Area 313 into the Crib 314, maintaining the route order. Each Crib's grid configuration is designed such that packages do not shift or fall but rather are stored securely maintaining their order and assigned position.

Step 7: once the Cribs are loaded with packages, the Cribs are transferred into the delivery vehicle. This can be done by an automated forklift (or by a conventional non-automated forklift) or by Tractive Robots, which are another part of this invention described below.

The above steps are iteratively repeated until all the packages in the batch have been processed.

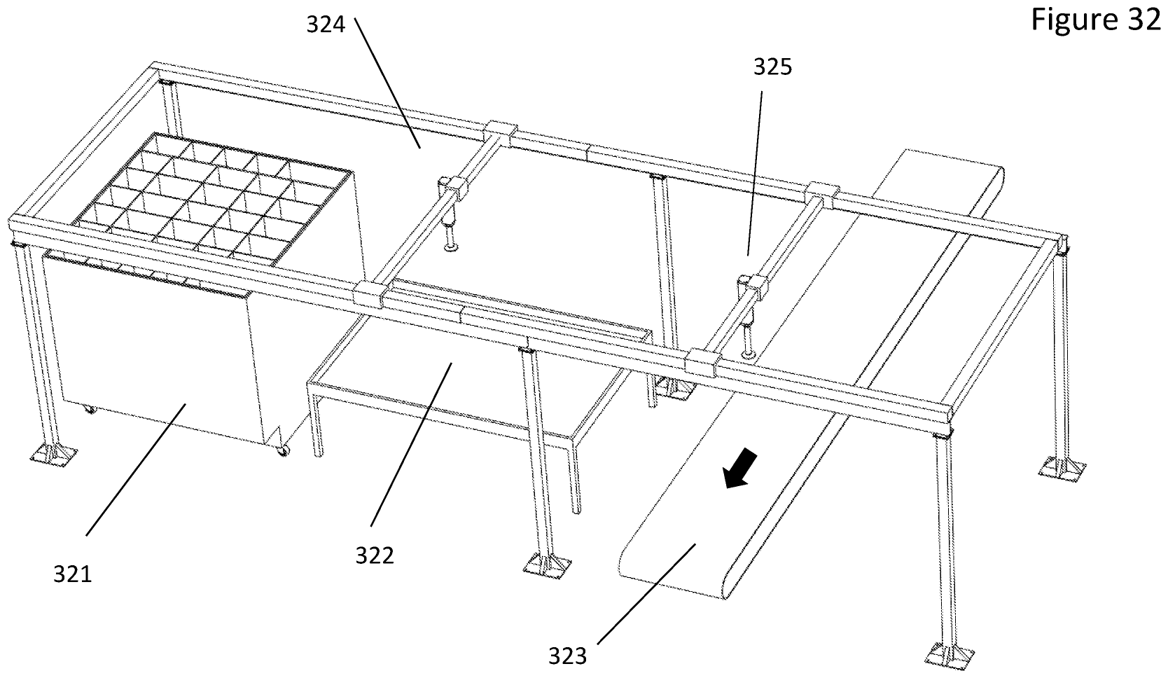

FIG. 32 shows a Load Cell that is integrated into the operation of the warehouse or distribution center, rather than merely attached to it as a secondary operation as previously shown in FIG. 31. The packages in the warehouse are either already on warehouse conveyor belt 323, or if they are in storage at the warehouse, the warehouse already has a system in place to pick them from storage and transfer them to the conveyor belt. The Integrated Load Cell can pick the packages to be delivered from conveyor belt 323 with its overhead robot 325 (preferably a Cartesian Robot), which transfers the packages to the Sorting Table 322, where the packages are arranged in reverse delivery route order by Robot 324 (also preferably, but not limited to a Cartesian Robot). In the next step, Robot 324 transfers the sorted packages from the Sorting Area to Crib 321. When the Crib is full, the Crib is transferred to an RDV by forklift or by a Tractive Robot (described herein below).

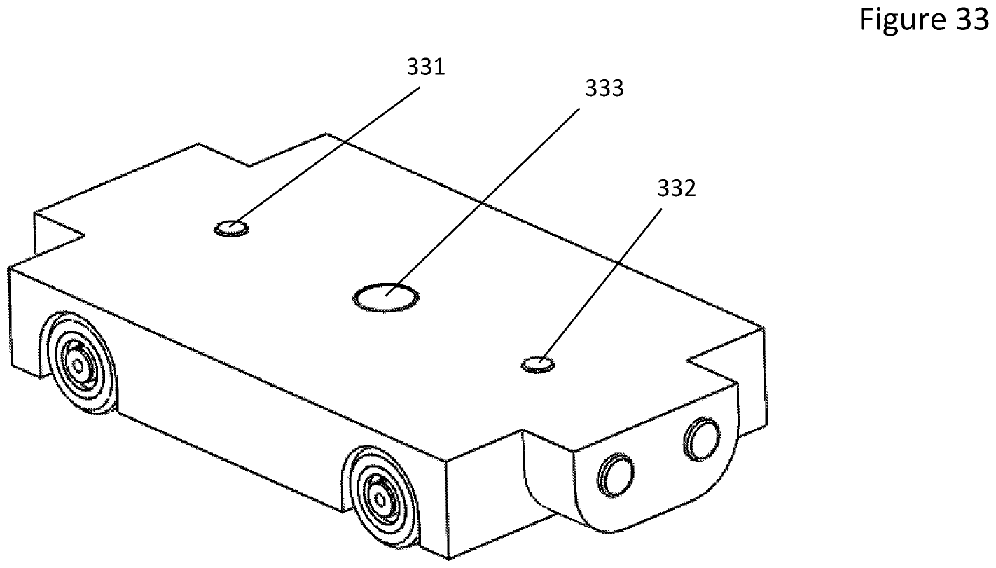

In a preferred embodiment of this invention, Cribs typically have four wheels that can swivel in any direction (in some embodiments Cribs can be provided without wheels, especially if the loading into the vehicle is to be done by forklift). The Tractive Robots can be used to move wheeled Cribs in any desired direction with relatively small effort, because the wheels of the Crib carry the weight and only the rolling resistance needs to be overcome, which is fairly low. FIG. 33 shows the Tractive robot of this invention.

Tractive Robots are self-driving robots that can fit underneath the object to be moved because of their low profile. The Tractive robot crawls under an object to be moved, such as a Crib. It then deploys two or more pins 331 and 332 into mating holes in the Crib or other target object. The pins do not bottom out in the mating holes, because their purpose is not to lift the Crib, but instead just to transmit horizontal forces to the Crib, to push the Crib while the Crib rolls on its own wheels. When the Tractive Robot moves, it pushes the Crib along via the engagement pins. At least two pins are desirable in general to be able to impart a rotation to the Crib when the path requires steering. In this Figure all the pins are shown in retracted position.

The larger optional pin in the middle 333 is not for propulsion and it does not mate with a hole on the opposite side. Its purpose is just to push up against the Crib, without any intention to lift it, just to increase the load on the Tractive wheels, creating better traction, when needed (such as in wet or slippery surfaces or potentially when going up a grade or a ramp).

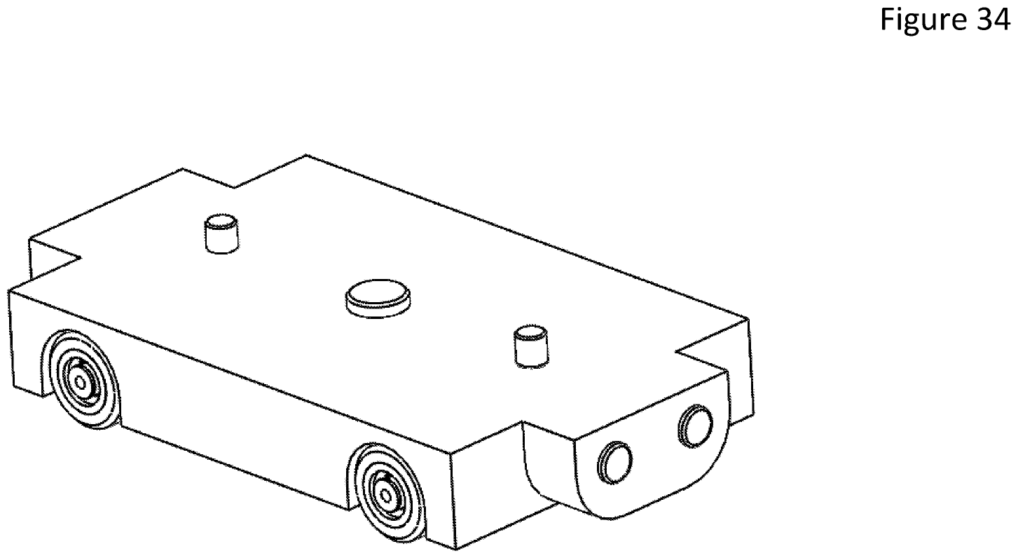

FIG. 34 shows the Tractive Robot's engagement pins in deployed position, and the traction pin in the middle slightly raised to increase traction.

Because of its unique design, the Tractive robot does not need to lift weight and it only needs to overcome the rolling resistance of the Crib, which is low. This enables a very slim, low profile that makes it possible to use it with objects that have small clearances to the floor, such as the Cribs. They can be used singularly, or in a team of two or more robots, together moving a load. The Tractive robot can crawl under a Crib, engage its pins with the Crib, and then propel the Crib in any direction, through a warehouse, through the loading dock, up/down a ramp, into the RDV, and so on. The Crib needs to be equipped with brakes or stops to immobilize it when necessary (for instance, inside the delivery vehicle).

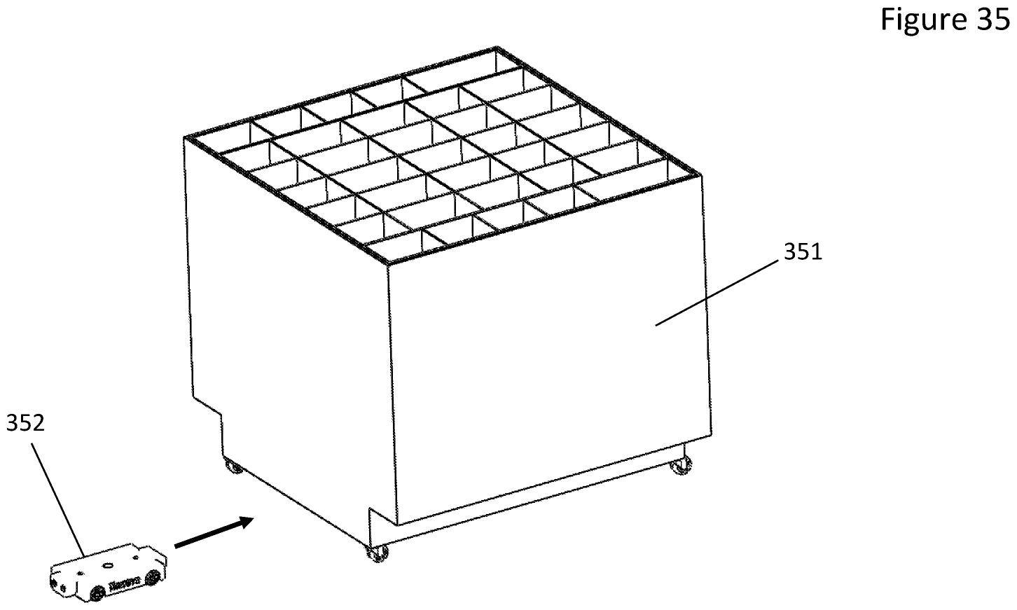

FIG. 35 shows a Tractive Robot 352 approaching Crib 351, about to “crawl” under it in order to move it to another location.

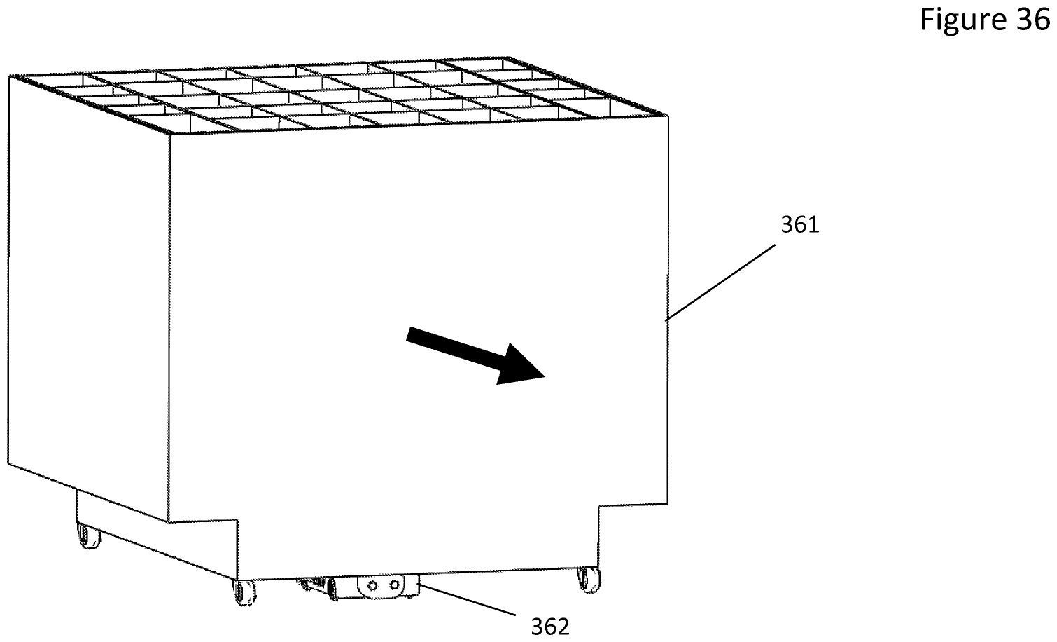

FIG. 36 shows Crib 361 being propelled by the small Tractive Robot 362 underneath it.

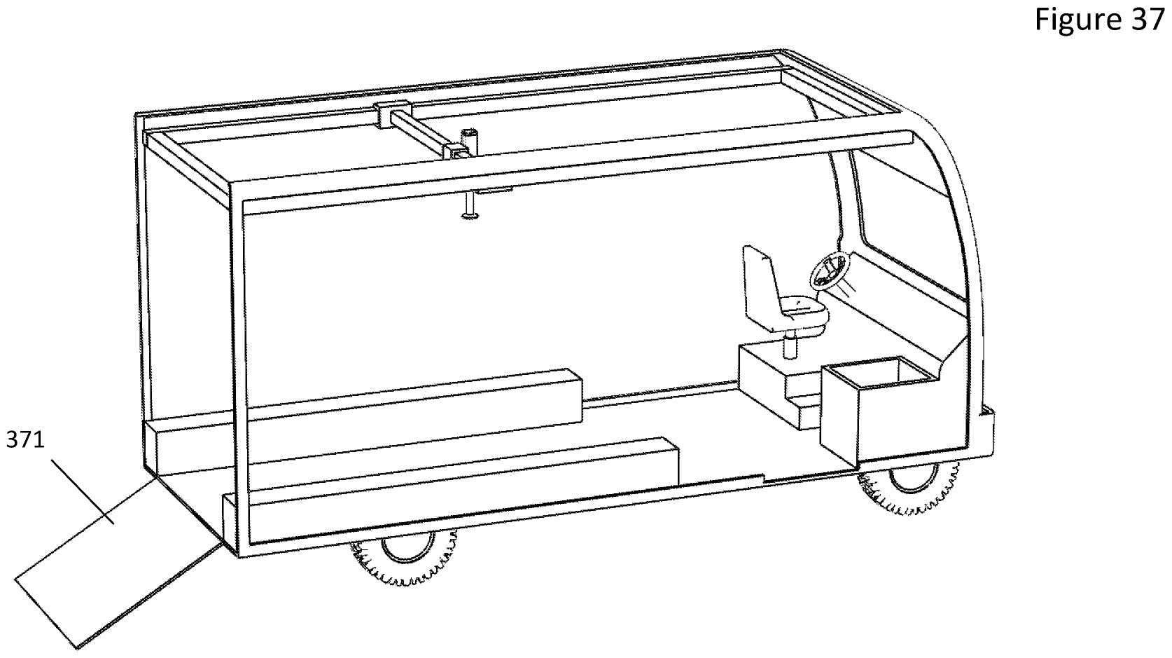

FIG. 37 shows that the RDV can be equipped with a rear ramp, which can be manually, mechanically, electrically, or otherwise deployed and retracted. The rear ramp 371 facilitates the loading of the Cribs inside the cargo area of the RDV, which can be done by the Tractive Robots. The rear ramp 371 can additionally be equipped with a rack (linear gear), to facilitate the pushing up the ramp without potential slippage by the Tractive robot (s). Other alternatives to loading the Cribs are: stand-alone ramps on the ground that provide the necessary angle for the Tractive robots to propel the Cribs onto the RDV, or a loading dock, or a typical forklift (automated or standard) as previously shown in FIG. 5 or a similar loading machine. The Tractive robots have the advantage of speed, flexibility and no need for human operators.

FIG. 38 shows the preferred embodiment of the Telescopic Actuator for this invention. The design challenge with this essential component of the RDV is that it requires a very long stroke to reach packages at every level of the vehicle, near the roof, or near the floor, or in-between. At the same time, it needs to have a very small retracted length, because it cannot hit the roof of the RDV when it is retracting. The innovative structure of FIG. 38 is a cost-effective, fast and reliable solution to this challenge.

The Telescopic Actuator of FIG. 38 consists basically of several concentric cylinders nested into each other. Cylinder 381 is the innermost cylinder, 382 is the middle cylinder, and 383 is the outermost cylinder. For simplicity of drawing and explanation, FIG. 38 shows only 3 cylinders, while in reality the RDV will likely have about 6 nested cylinders to provide the necessary stroke.

The outermost cylinder 383 is fixedly attached to bridge 384 of the Cartesian Robot, hence it has a fixed height in the vehicle, it cannot move up and down. By contrast, cylinder 382 is free to slide down inside cylinder 383, but right now it cannot, because of the cable/rope 385, which is taut and prevents the innermost cylinder 381 from sliding down. The top of cylinder 381 is engaging cylinder 382 and preventing it from sliding down—see arrow with the symbol E1 for first engagement in FIG. 38 pointing at the area of engagement.

This mechanism will descend by gravity when cable 385 gradually allows the innermost cylinder 381 to descend. As the cable extends, the innermost cylinder goes down, allowing the middle cylinder to descend as well, and the mechanism extends downwards.

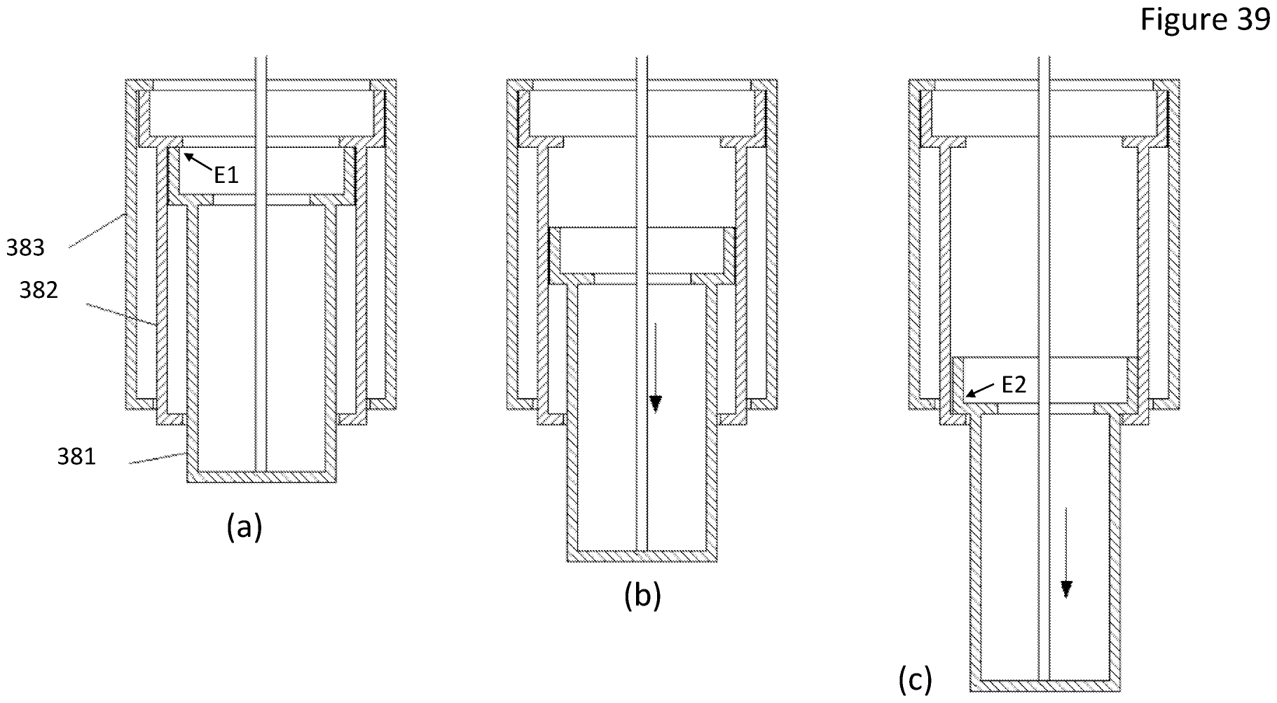

FIG. 39 shows the Telescoping Actuator is 3 different positions. Position (a) shows the actuator in its fully retracted position. Position (b) shows the innermost cylinder descending as the cable extends downward. Position (c) shows the innermost cylinder fully extended, and now starting to engage the middle cylinder (see arrow with the symbol E2 for second engagement, pointing at area of engagement).

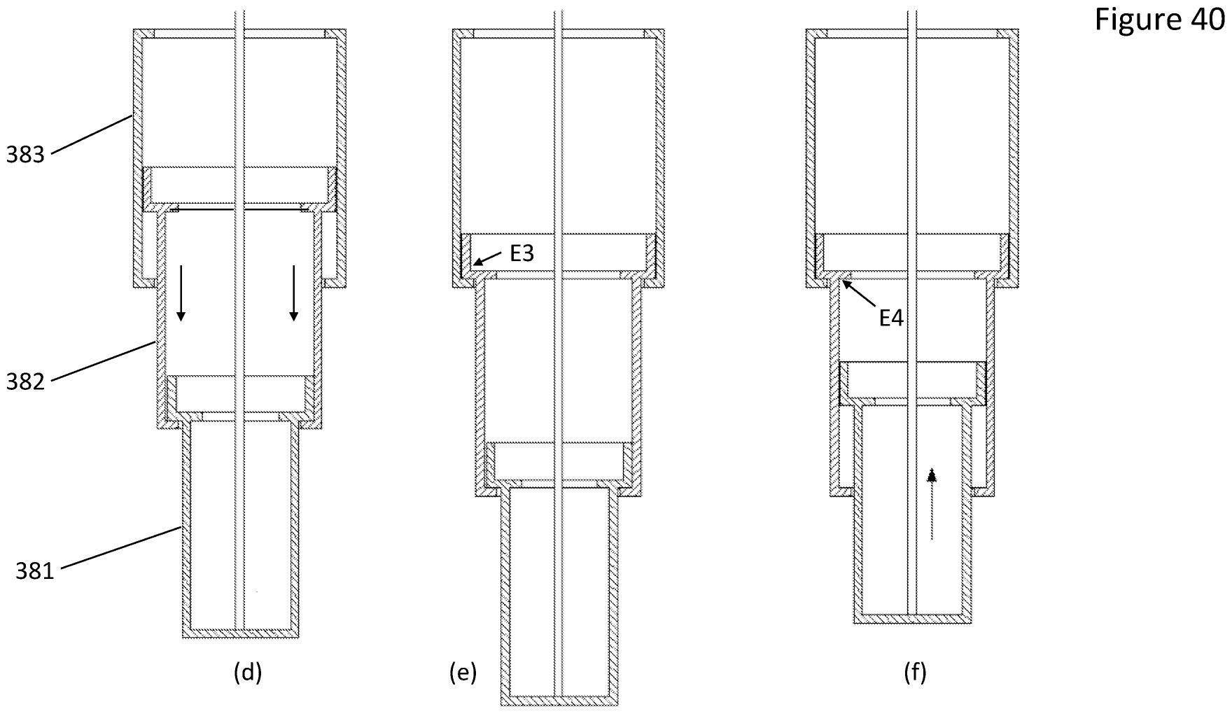

FIG. 40 shows the Telescoping Actuator in the next 3 different positions in its descent. Position (d) shows the middle cylinder 382 moving downward in its deployment as the cable extends further.

Position (e) shows the innermost cylinder in its lowest position, it cannot move further down because it has engaged at this point with the outermost fixed cylinder—see arrow pointing at engagement area E3. The Telescoping Actuator at this point has reached its maximum stroke, because in this example we have only 3 cylinders. With more cylinders more stroke can be attained, with the same methods described above.

Position (f) shows that the cable is now pulling up, and the Actuator is starting to retract. The cable is pulling up the innermost cylinder. The next area of engagement in the upward travel is going to be E4 (see arrow). The cable continues to lift until the whole Actuator is fully retracted, which is the original situation depicted in FIG. 39, Position (a).

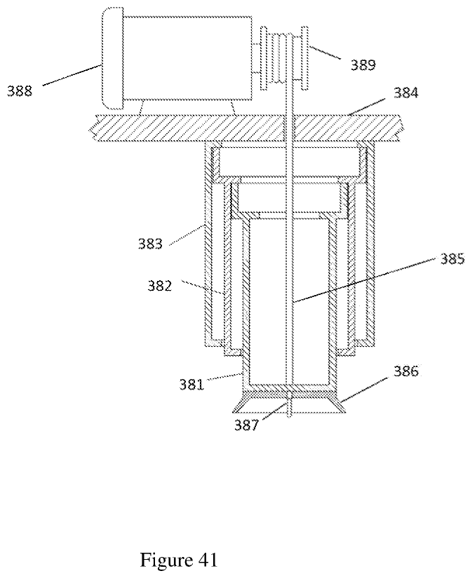

FIG. 41 shows an electric motor 388 mounted on top of the bridge 384, turning a pulley 389, which winds and unwinds the cable, lifting the cable or lowering it to achieve the desired stroke. This mechanism is continuously adjustable with infinite stroke positions.

At the bottom of the innermost cylinder 381 a suction cup 386 is attached in order to attach to packages and lift them as needed. Position sensor 387 is also located at the bottom of the innermost cylinder. The preferred type of sensor in this embodiment is just a switch that will report contact when the sensor probe touches the target package in its descent, stopping the motor. A camera (not depicted in this Figure) is also attached to the Actuator in order to scan packages and read identification labels. Additional cameras could be installed in other areas of the Actuator for general situation awareness and safe operation. The cable 385 can be used just like a rope, but in this or in other embodiments it can also achieve multiple other purposes, such as conducting electricity and electrical signals with built-in electric wires to support the sensor and cameras, or serve as guidance and support for the vacuum lines for the suction cup, which can be loosely wound around the cable.

The described Telescoping Actuator is the preferred mechanism in this invention to achieve the operating requirements in terms of stroke, retracted length, speed, weight, absence of oil or air leaks, no need for seals, reliability, and longevity of the solution. Other possible options that can be used to implement the teachings of this disclosure include hydraulic, pneumatic, electrical, mechanical, electromechanical, magnetic, scissor mechanisms, ropes and cables, flexible racks and pinion mechanisms, and other types of mechanisms, all within the scope of this invention.

BENEFITS OF THE EMBODIMENTS: The present embodiments exemplify a novel delivery system with key innovations that can substantially structure and automate the delivery process, thereby drastically reducing the cost of delivery. The structure described in the Specification ensures consistency, repeatability and predictability in the delivery process, which are essential for successful automation.

Robots are not good at handling chaos and improvising; they need an ecosystem with structure and order. If provided with such an environment, they can work extremely well and cut costs by orders of magnitude. This invention creates that necessary environment.

Other benefits of the invention include:
extremely high reliability, because the process is all computer-driven;
fast delivery to customers, making same day delivery viable;
lower product prices (delivery is never “free”, it is always factored into the product price);
expanded hiring pool for drivers (no heavy lifting required anymore); and
it paves the way for further growth of ecommerce in the future once self-driving is approved, by creating the automation ecosystem that will make its implementation feasible.

The preceding description shows some of the preferred embodiments of the invention as examples of implementation. It is understood that a person skilled in the art could, in light of these disclosures, conceive other derived embodiments, modify the disclosed embodiments or conceive variations of them, which would all still be part of the present invention.

1. An automated package delivery vehicle comprising:
an electric, hybrid or otherwise propelled vehicle;
at least one robotic system on board the vehicle, configured to search for, identify, pick, reorganize and transfer packages from one location to another location within the vehicle, and to collect the package (s) needed for the next route stop and transfer them to a staging area in the vehicle with access by a crew, all of these functions performed without assistance from the crew and performed during drive time between stops;
a vehicle cargo area directly accessible to a crew or service personnel aboard or adjacent the vehicle.

2. The automated package delivery vehicle of claim 1, wherein the cargo area of the vehicle is substantially clear and empty (with the exception of the cargo handling robot), configured for rapid insertion of large Cribs previously filled outside the vehicle with route-sorted packages during vehicle loading.

3. The automated package delivery vehicle of claim 1, wherein the at least one robotic system comprises a Telescopic Actuator, which may be actuated through hydraulic, pneumatic, electric, magnetic, flexible rack and pinion, cables and ropes, extensible scissor devices, or multi-stage telescoping pneumatic and hydraulic cylinders, whereby the Actuator achieves a stroke in excess of its retracted length and reaches substantially all or most of the internal volume of the vehicle.

4. The automated package delivery vehicle of claim 3, wherein the Telescoping Actuator is equipped with at least one of: scanners, sensors, cameras, selectable grippers and suction cup; thereby enabling the Telescoping Actuator to search for next-in-sequence packages to be delivered, identify said packages and retrieve said packages for delivery.

5. The automated package delivery vehicle of claim 3, wherein the Telescoping Actuator comprises nested cylinders deployed by gravity and retracted by a cable that can be extended or retracted by an electric motor, with position sensor/switch and suction cup at the end of the actuator.

6. The automated package delivery vehicle of claim 3, wherein the vehicle has at least one staging area in or accessible from a cabin area, and wherein package (s) for a next stop are deposited into the staging area by the robotic system to make them readily available for the crew upon arrival at said next stop.

7. The automated package delivery vehicle of claim 6, wherein the robotic system puts the package (s) for the next stop into a carrying bag or box in the at least one staging area, accessible for the crew to grab and deliver.

8. The automated package delivery vehicle of claim 7, wherein the bag or box comprises a robotic delivery bag, comprising: structure to maintain the bag in an open configuration for loading of packages by a robot or for extraction of packages by a robot, and a weighted bottom to maintain the bag in a position in the staging area.

9. The automated package delivery vehicle of claim 3, wherein the robotic system is configured to provide a human driver with a package or batch of packages ready to deliver, whereby the driver need not search, sort, scan or pick packages to be delivered.

10. The automated package delivery vehicle of claim 3 wherein the crew comprises a human driver and at least one delivery robot assistant configured to deliver some or all the packages.

11. The automated package delivery vehicle of claim 3 wherein the crew comprises a human driver and at least one quadruped delivery robot.

12. The automated package delivery vehicle of claim 11, wherein the robotic system is configured to: select one or more of the packages for delivery at a next stop, and load the selected packages directly into a built-in bin of the quadruped delivery robot.

13. The automated package delivery vehicle of claim 10, wherein the robotic system is configured to: select one or more of the packages for delivery at a next stop, and hand the selected packages over directly into either (a) arms of a biped delivery robot, (b) the staging area, or (c) a robot delivery bag in the staging area.

14. The automated package delivery vehicle of claim 10, wherein the vehicle further comprises a manually or automatically deployable ramp for use by the delivery robot assistant while exiting and re-entering the vehicle.

15. The automated package delivery vehicle of claim 1 wherein:
the crew comprises at least one last yard robot but does not include any humans;
the vehicle is configured for autonomous driving; and
the at least one last yard robot is configured to deliver the packages from the vehicle to a customer door dropoff location.

16. The automated package delivery vehicle of claim 15, wherein the vehicle is driven by a biped robot, and the deliveries are performed by the biped robot with the assistance of a quadruped robot.

17. The vehicle of claim 16, wherein a vehicle computer control system assigns the packages amongst the biped robot and the quadruped robot based at least in part upon each of said robot's capabilities and characteristics of the packages.

18. An automated package delivery system comprising:
a package delivery vehicle comprising a vehicle cargo area accessible to a crew or service personnel aboard the vehicle, the vehicle configured to transport cargo comprising packages according to a delivery route comprising one or more stops at which a subset of the packages are to be delivered;
an automated system that, during vehicle transit to a route stop, picks up one or more of the packages to be dropped off at said route stop out of the vehicle cargo area and transfers said packages to a staging area accessible from within the vehicle, without a need for the crew to search for packages and extract them from the cargo area; and
a vehicle loading system (Load Cell) that allows the loading of cribs into the vehicle, said cribs having been previously loaded outside the vehicle with one or more route-sorted packages.

19. The automated package delivery system of claim 18, in which the cribs have internal compartments in a vertical orientation with different sizes, wherein the packages are stacked in a delivery routing order and wherein the compartments are sized to prevent shifting, shuffling or mingling of packages due to vehicle movement, whereby preservation of the routing sequence may be preserved during vehicle transit.

20. The automated package delivery system of claim 19 wherein the crib compartments are re-configurable by extracting and relocating dividers within the Crib.

21. The automated package delivery system of claim 18, in which the load cell comprises a Warehouse—attached Load Cell, which receives bags with packages from a warehouse and loads them in routing order into the Cribs, which are then inserted into the vehicle.

22. The automated package delivery system of claim 18, in which the load cell comprises a warehouse-Integrated Load Cell, integrated into warehouse operations to retrieve packages directly from one or more warehouse conveyor belts and then loads the packages in routing order into the Cribs, which are then inserted into the vehicle.

23. A biped robot with two feet comprising a plurality of rollers for each foot, said rollers being switchable between propelled and locked modes of operation; thus enabling at least two modes of locomotion: rolling locomotion on said rollers in a propelled mode, or walking locomotion on said rollers while locked, whereby the rolling locomotion may be utilized for rapid movement on flat surfaces while the walking locomotion enables climbing of stairs and overcoming of obstacles.

24. The robot of claim 23, wherein the robot's feet are longitudinally extendable and laterally extendable to provide enhanced stability.

25. The robot of claim 24, wherein said rollers may be operated, lowered, raised or tilted individually or in subsets, in order to exert forces against a ground surface to stabilize the robot.

26. A quadruped robot with feet that each include a plurality of rollers, said rollers being switchable between propelled and locked modes of operation; thus enabling at least two modes of locomotion: rolling locomotion on said rollers in a propelled mode, or walking locomotion on said rollers while locked, whereby the rolling locomotion may be utilized for rapid movement on flat surfaces while the walking locomotion enables climbing of stairs and overcoming of obstacles.

27. The quadruped robot of claim 26, further comprising at least one bin on its top and/or its sides to store objects to be carried, said bin being subdividable into compartments where packages for different nearby customers can be stored simultaneously, said bin further comprising a system of doors or stops or restraints acting on the packages.

28. The quadruped robot of claim 26, wherein the robot bin is movable to an angled position at a delivery point, the bin further comprising a lid configured to open at the delivery point, whereby packages within the bin may slide down using the lid as a downward ramp, thus performing the drop-off without any human assistance.

29. The quadruped robot of claim 28, further comprising one or more pushers configured to eject one or more packages from the bin at the delivery point.

30. A Tractive robot configured to pass under a wheeled crib in an automated package delivery system, engage a deployable mechanical pin into mating holes in an underside of said crib, and then move the crib by applying traction to a ground surface on which the tractive robot and crib rest, without lifting the crib, whereby the crib rolls on its own wheels so that the Tractive robot only needs to overcome rolling resistance to transport the crib without a need to lift the crib.

31. The Tractive robot of claim 30, further comprising a pressure rod deployed from a top surface of the robot to push against a portion of the underside of the crib, without entering a mating hole, in order to create a reaction force from the ground surface that increases traction between the robot and ground surface.
